(19) United States
(12) Patent Application Publication
(10) Pub. No.: US 2009/0076914 A1
(43) Pub. Date: Mar. 19, 2009

(54) PROVIDING COMPENSATION TO SUPPLIERS OF INFORMATION

(76) Inventor: Philippe Coueignoux, Tewksbury, MA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/189,956

(22) Filed: Aug. 12, 2008

Related U.S. Application Data
(60) Provisional application No. 60/973,565, filed on Sep. 19, 2007.

(51) Int. Cl. G06Q 30/00

(52) U.S. Cl. 705/14

(57) ABSTRACT

The invention relates to providing compensation to suppliers of information, particularly in an on-line, web-based environment. In one embodiment, a server computing device is in communication with a storage device, and is configured to interact over a communications system with one or more client computing devices. Each of the client computing devices has associated therewith one or more user profiles, each of the user profiles includes one or more user profile information items from one or more suppliers. The server computing device is configured to execute software that results in compensation to one or more of the suppliers.

### RELATED APPLICATION

This application claims priority to and the benefit of provisional U.S. patent application Ser. No. 60/973,565 filed Sep. 19, 2007, the entirety of which is hereby incorporated by reference herein.

### TECHNICAL FIELD

The invention relates to apparatuses and methods for providing compensation to suppliers of information, particularly in an on-line, web-based environment.

### BACKGROUND INFORMATION

The more time consumers spend on interactive electronic networks, the more attractive these new media become to advertisers. Mass advertising, e.g., broadcasting an advertisement on television regardless of the audience, is no longer the preferred approach to reach consumers. Advertisers want to take advantage of the fact that when a consumer interacts with a networked device, this device is capable of tailoring its messages to that particular consumer profile, i.e., targeted or personalized advertising.

### SUMMARY OF THE INVENTION

A user's interaction with a web page, such as by surfing or browsing the web page or clicking on items on the web page, can be tracked and captured and can provide information about the user. This information typically is held by an entity, for example a business or vendor, that owns or controls the web site with which the user is interacting. Further, this information is valuable to an advertiser that would like to utilize the information about the user so that the advertiser can tailor advertising to the user's interests, thus increasing the likelihood that the user will click on the advertisement that is presented on the web pages visited by the user. Compensation in the form of money and or something else of value can be provided to the entities that own or control the visited web pages or that otherwise possess information about the user in exchange for providing that information. With this information, better targeted advertisements can be provided to a browsing user.

In one aspect, the invention generally relates to apparatus for providing compensation to suppliers of information, particularly in an on-line, web-based environment. Suppliers of information can also be referred to as fact furnishers, in keeping with the practice of the credit reporting industry. The apparatus comprises a storage device and a server computing device in communication with the storage device. The server computing device is configured to interact over a communications system with one or more client computing devices. Each of the client computing devices is associated with one or more user profiles. Each of the user profiles includes one or more user profile information items. Each of the user profile information items is directly or indirectly from one of one or more suppliers. The server computing device is also configured to execute software that results in certain functionality. For each user profile, the software collects the user profile information items based on a user employing one of the client computing devices to access over the communications system web pages of one or more of the suppliers. For each user profile, the software also determines the identity of each of the suppliers associated with each of the collected user profile information items, and stores in the storage device information about those identities and associations. For each user profile, the software also selects, based on the user profile, one or more advertisements from a plurality of possible advertisements, and stores in the storage device the selected advertisements and information about the user profile upon which the selection was based. For each user profile, the software also presents one or more of the selected advertisements as a user employs one of the client computing devices to access over the communications system web pages that include one or more advertisement spaces. For each user profile, the software also accesses at least some of the information stored in the storage device to determine the identity of at least one of the suppliers associated with at least one of the user profile items used in the selection of at least one of the presented advertisements. For each user profile, the software also provides compensation to at least the at least one supplier whose identity was determined.

Embodiments according to this aspect of the invention can have various features. For example, the storage device can comprise computer storage in one or more of the server computing device, one or more external storage units local to the server computing device, and one or more external storage units remote from the server computing device. The server computing device can comprise a single general purpose computer or multiple general purpose computers. Each of the suppliers can comprise a business entity. The business entity can comprise web pages containing content and a dynamic executable module.

The server computing device can present one or more of the selected advertisements upon a request from the web pages that includes the advertisement spaces through a dynamic executable module. The server computing device can provide compensation to each of the suppliers associated with each of the user profile items used in the selection of at least one of the presented advertisements. The compensation can be, for example, one or more of points, money, or credits. The plurality of possible advertisements can be received from advertisers that elect to interact through the communications system with the apparatus. The server computing device can also charge an advertiser associated with the presented advertisement.

The server computing device can collect the user profile information items by at least one rule. The server computing device can also determine whether an identical user profile information item is provided by more than one supplier. The server computing device can also determine whether a newly collected user profile information item is consistent with the user profile by referring to a list of consistency rules. The server computing device can also keep the user profile current by referring to a list of updating rules. A supplier can obtain exclusivity over the sourcing of a user profile information item.

The server computing device can also derive at least one additional user profile information item based on an existing user profile. The server computing device can also provide compensation to at least the at least one supplier of the user profile information item in the user profile that contributed to a derived user profile information item. The server computing device can further execute at least one derivation according to a derivation rule, supplied by a rule supplier. The server computing device can further provide compensation to the rule supplier of the at least one derivation rule used to derive a user profile information item.

The server computing device can perform the selecting by comparing one or more selection criteria embedded in the one or more advertisements against the information items in the user profile.

In another aspect, the invention generally relates to apparatus for providing compensation to suppliers of information. The apparatus comprises a storage device and a client computing device configured to interact over a communications system with one or more server computing devices. The client computing device is in communication with the storage device that is maintained inside a security wall on the client computing device. The storage device holds one or more user profiles. Each of the user profiles includes one or more user profile information items. Each of the user profile information items is directly or indirectly from one of the one or more suppliers. The security wall prevents an outside entity from accessing user profile information items within the user profile, and also prevents release of user profile information items within the user profile to the outside entity. The client computing device is also configured to execute software that is maintained inside the security wall that results in certain functionalities. For each user profile, the software collects the user profile information items based on a user employing the client computing device to access over the communications system web pages of one or more of the suppliers. For each user profile, the software determines the identity of each of the suppliers associated with each of the collected user profile information items, and stores in the storage device information about those identities and associations. For each user profile, the software selects, based on this user profile, one or more advertisements from a plurality of possible advertisements that it receives from the at least one server computing device, and stores in the storage device the selected advertisements and information about the user profile upon which the selection was based. For each user profile, the software releases the minimum information necessary for the client computing device to present one or more of the selected advertisements as a user employs the client computing device to access over the communications system web pages that include one or more advertisement spaces. For each user profile, the software accesses at least some of the information stored in the storage device to determine the identity of at least one of the suppliers associated with at least one of the user profile items used in the selection of at least one of the presented advertisements. For each user profile, the software provides compensation to at least the at least one supplier whose identity was determined. The software also releases the minimum amount of information necessary to report supplier compensation to a server computing device, excluding reference to: individual users; user profiles; or advertisements upon which selection was based.

Embodiments according to this aspect of the invention can have various features. For example, a server computing device can comprise a single general purpose computer or multiple general purpose computers. The apparatus can further comprise an anonymizing proxy server used by the client computing device to communicate with server computing devices. Each of the suppliers can comprise a business entity. The business entity can comprise web pages containing content and a dynamic executable module.

The client computing device can present one or more of the selected advertisements upon a request from the web pages that includes the advertisement spaces through a dynamic executable module. The client computing device can provide compensation to each of the suppliers associated with each of the user profile items used in the selection of at least one of the presented advertisements. The compensation can be, for example, one or more of points, money, or credits. The plurality of possible advertisements can be received from advertisers that elect to interact through the communications system with the apparatus. The client computing device can also charge an advertiser associated with the presented advertisement.

The client computing device can collect the user profile information items by at least one rule. The client computing device can also determine whether an identical user profile information item is provided by more than one supplier. The client computing device can also determine whether a newly collected user profile information item is consistent with the user profile by referring to a list of consistency rules. The client computing device can also keep the user profile current by referring to a list of updating rules. A supplier can obtain exclusivity over the sourcing of a user profile information item.

The client computing device can also derive at least one additional user profile information item based on an existing user profile. The client computing device can also provide compensation to at least the at least one supplier of the user profile information item in the user profile that contributed to a derived user profile information item. The client computing device can further execute at least one derivation according to a derivation rule, supplied by a rule supplier. The client computing device can further provide compensation to the rule supplier of the at least one derivation rule used to derive a user profile information item.

The client computing device can perform the selecting by comparing one or more selection criteria embedded in the one or more advertisements against the information items in the user profile.

The client computing device can allow a user to have free access to data within the security wall and secure the corresponding user profile as his or her user profile. The client computing device can allow the user to prevent a specific supplier of user profile information from contributing a user profile information item. The client computing device can allow the user to edit the corresponding user profile. The security wall policy can allow the user to authorize the release from within of designated items in the corresponding user profile.

In another aspect, the invention generally relates to method for providing compensation to suppliers of information. The method comprises providing one or more client computing devices to access one or more server computing devices in communication with one or more storage devices. Each of the server computing devices is configured to interact over a communications system with each of the client computing devices. Each of the client computing devices has associated therewith one or more user profiles. Each of the user profiles includes one or more user profile information items. Each of the user profile information items is directly or indirectly from one of the one or more suppliers. For each user profile, the method further comprises collecting the user profile information items based on a user employing the computing devices to access over a communications system web pages of one or more of suppliers. For each user profile, the method further comprises determining the identity of each of the suppliers associated with each of the collected user profile information items, and storing in the storage device information about those identities and associations. For each user profile, the method further comprises selecting, based on the user profile, one or more advertisements from a plurality of possible advertisements, and storing in the storage device the selected advertisements and information about the user profile upon which the selection was based. For each user profile, the method further comprises presenting one or more of the selected advertisements as the user employs one of the client computing devices to access over the communications system web pages that include one or more advertisement spaces. For each user profile, the method further comprises accessing at least some of the information stored in the storage device to determine the identity of at least one of the suppliers associated with at least one of the user profile items used in the selection of at least one of the presented advertisements. For each user profile, the method further comprises providing compensation to at least the at least one supplier whose identity was determined.

Embodiments according to this aspect of the invention can have various features. For example, the storage device can comprise computer storage in one or more of the server computing device, one or more external storage units local to the server computing device, and one or more external storage units remote from the server computing device. The server computing device can comprise a single general purpose computer or multiple general purpose computers. The suppliers can comprise business entities. The business entities have, for example, web pages that contain content and a dynamic executable module.

The method can present one or more of the selected advertisements upon a request from the web pages that include the advertisement spaces through a dynamic executable module. The method can further comprise providing compensation to each of the suppliers associated with each of the user profile items used in the selection of at least one of the presented advertisements. The compensation can be, for example, one or more of points, money, or credits. The plurality of possible advertisements can be received from advertisers that elect to interact through the communications system with the apparatus. The method can further comprise charging an advertiser associated with the presented advertisement.

The method can include referring to at least one rule to collect the user profile information items. The method can further comprise determining whether an identical user profile information item is provided by more than one supplier. The method can accomplish the selecting step by comparing one or more selection criteria embedded in the one or more advertisements against the information items in the user profile.

The method can further comprise determining whether a newly collected user profile information item is consistent with the user profile by referring to a list of consistency rules. The method can further comprise keeping the user profile current by referring to a list of updating rules. The method can allow for a supplier to obtain exclusivity over the sourcing of a user profile information item.

The method can further comprise deriving at least one additional user profile information item based on an existing user profile. The method can further comprise providing compensation to at least the at least one supplier of the user profile information item in the user profile that contributed to a derived user profile information item. The method further includes executing at least one derivation according to a derivation rule, supplied by a rule supplier. The method further includes providing compensation to the rule supplier of the at least one derivation rule used to derive a user profile information item.

In another aspect, the invention generally relates to method for providing compensation to suppliers of information. The method comprises providing one or more client computing devices configured to interact over a communications system with one or more server computing devices. Each of the client computing devices is in communication with a storage device that is maintained inside a security wall on each of the client computing devices. The storage device holds one or more user profiles. Each of the user profiles includes one or more user profile information items. Each of the user profile information items is directly or indirectly from one of one or more suppliers. The security wall prevents an outside entity from accessing user profile information items within the user profile, and also prevents release of user profile information items within the user profile to the outside entity. For each user profile, the method further comprises collecting the user profile information items based on a user employing one of the client computing devices to access over the communications system web pages of one or more of the suppliers. For each user profile, the method further comprises determining the identity of each of the suppliers associated with each of the collected user profile information items, and storing in the storage device information about those identities and associations. For each user profile, the method further comprises selecting, based on this user profile one or more advertisements from a plurality of possible advertisements received from the at least one server computing device, and storing in the storage device the selected advertisements and information about the user profile upon which the selection was based. For each user profile, the method further comprises releasing the minimum information necessary for the client computing device to present one or more of the selected advertisements as a user employs one of the client computing devices to access over the communications system web pages that include one or more advertisement spaces. For each user profile, the method further comprises accessing at least some of the information stored in the storage device to determine the identity of at least one of the suppliers associated with at least one of the user profile items used in the selection of at least one of the presented advertisements. For each user profile, the method further comprises providing compensation to at least the at least one supplier whose identity was determined. The method also releases the minimum amount of information necessary to report supplier compensation to a server computing device, excluding reference to: individual users; user profiles; or advertisements upon which selection was based.

Embodiments according to this aspect of the invention can have various features. For example, a server computing device can comprise a single general purpose computer or multiple general purpose computers. The method further includes anonymizing communication between the client computing devices and the server computing devices by using an anonymizing proxy server. The suppliers can comprise business entities. The business entities have, for example, web pages that contain content and a dynamic executable module.

The method can present one or more of the selected advertisements upon a request from the web pages that include the advertisement spaces through a dynamic executable module. The method can further comprise providing compensation to each of the suppliers associated with each of the user profile items used in the selection of at least one of the presented advertisements. The compensation can be, for example, one or more of points, money, or credits. The plurality of possible advertisements can be received from advertisers that elect to interact through the communications system with the apparatus.

The method can further comprise charging an advertiser associated with the presented advertisement. The method can include referring to at least one rule to collect the user profile information items. The method can further comprise determining whether an identical user profile information item is provided by more than one supplier. The method can accomplish the selecting step by comparing one or more selection criteria embedded in the one or more advertisements against the information items in the user profile.

The method can further comprise determining whether a newly collected user profile information item is consistent with the user profile by referring to a list of consistency rules. The method can further comprise keeping the user profile current by referring to a list of updating rules. The method can allow for a supplier to obtain exclusivity over the sourcing of a user profile information item.

The method can further comprise deriving at least one additional user profile information item based on an existing user profile. The method can further comprise providing compensation to at least the at least one supplier of the user profile information item in the user profile that contributed to a derived user profile information item. The method further includes executing at least one derivation according to a derivation rule, supplied by a rule supplier. The method further includes providing compensation to the rule supplier of the at least one derivation rule used to derive a user profile information item.

The method can further comprise granting free user access to data within the security wall and securing the user profile. The method can further comprise preventing a specific supplier of user profile information from contributing a user profile information item. The method can further comprise editing the user profile. The method can further comprise letting the security wall release from within user-authorized designated items in the user profile.

These and other aspects, features, and benefits according to the invention will become clearer by reference to the drawings described below and also the description that follows.

### BRIEF DESCRIPTION OF THE DRAWINGS

The drawings are not necessarily to scale, and the drawings generally illustrate principles relevant to the invention that can help in understanding the invention.

FIG. 1 is a block diagram of an embodiment of the system showing different components of the profile-based targeted advertising system accounting for input from a fact furnisher. An “n” appearing after a number indicates one or more.

FIG. 2 is a block diagram of an embodiment of the system showing different components of the profile-based targeted advertising system accounting for input from a fact furnisher in which the system is configured to provide a high level of user privacy. An “n” appearing after a number indicates one or more.

FIG. 3 is a block diagram of an embodiment of the system showing interaction of the different components of the system for achieving fact furnisher input recognition in targeted advertising. An inverted L shape in the upper right corner of a block indicates one or more.

FIG. 4 details an embodiment of the data structures for a user profile to support fact furnisher input recognition in targeted advertising. An inverted L shape in the upper right corner of a block indicates one or more.

FIG. 5 details an embodiment of the data structures for a personalized ad store and fact furnisher accounts to support fact furnisher input recognition in targeted advertising. An inverted L shape in the upper right corner of a block indicates one or more.

FIG. 6 is a flow chart showing details of the process by which a fact furnisher provides an item of information to the user profile.

FIG. 7 is a flow chart showing details of the process by which the system accounts for contributions of each fact furnisher in the presentation of an advertisement.

FIG. 8 is a block diagram of an embodiment of the system configured to provide a high level of user privacy showing interaction of the different components of the system for achieving fact furnisher input recognition in targeted advertising. An inverted L shape in the upper right corner of a block indicates one or more.

FIG. 9 is a diagram of an embodiment showing details of data structures used to streamline the selection of personalized advertising from a general advertisement store. An inverted L shape in the upper right corner of a block indicates one or more.

FIG. 10 is a block diagram of an embodiment of the system showing a rule-based process by which a fact furnisher indirectly provides an information item to the user profile. An inverted L shape in the upper right corner of a block indicates one or more.

FIG. 11 details an embodiment of the data structures for a user profile showing a process by which the system supports an information item indirectly provided by a fact furnisher. An inverted L shape in the upper right corner of a block indicates one or more.

FIG. 12 is a block diagram of an embodiment of the system showing a process by which the system supports user involvement in targeted advertising. An inverted L shape in the upper right corner of a block indicates one or more.

### DESCRIPTION

A general aspect of the present invention relates to a system for accounting for the contributions of a supplier of user profile information for generation of a user profile for personalized advertising. In general, each time a user sees an advertisement or clicks on an advertisement that had been selected on the basis of user profile information items contained in the user profile, the advertising system manager recognizes and compensates each of the suppliers of user profile information that provided a user profile information item that contributed to that advertisement being presented.

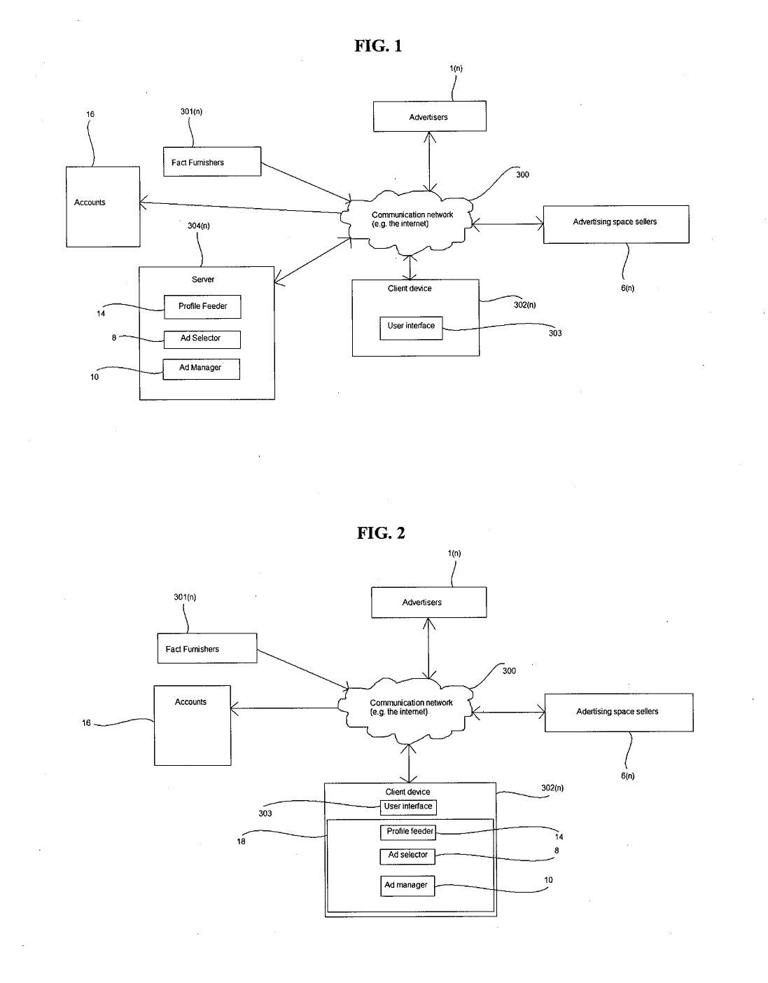

Referring to FIG. 1, which shows an embodiment of the system providing different components of the profile-based targeted advertising system accounting for input from a supplier. In one embodiment, the system uses three applications that run on server 304(n) (“n” after the 304 indicates one or more), within one of one or more computing environments, and holding a user profile, a personalized ad store and a version of the fact furnishers' accounts. The first application, the profile feeder 14, receives information items from one or more suppliers of user profile information, i.e., fact furnishers 301(n) as one or more users interact through client interface 303 in one or more client devices 302(n) and through a communication network 300 with the one or more suppliers for their own purposes. The profile feeder 14 stores those information items into the user profile, together with the information necessary to trace each information item back to each contributing fact furnisher.

The second application, the ad selector 8, receives generic advertisements from one or more advertisers 1(n) through communication network 300 and compares the selection criteria attached to each advertisement against the user profile. The ad selector 8 stores those advertisements whose targets the user profile satisfies into the personalized ad store, together with the information necessary to trace each advertisement back to all the information items supporting its selection.

The third application, the personal ad manager 10, retrieves advertisements from the personalized ad store in response to requests from one or more advertising space sellers 6(n) as the user interacts through user interface 303 in one or more client devices 302(n) and through communication network 300 with the web page of the one or more advertising space sellers 6(n) for their own purposes. The personal ad manager 10 delivers those advertisements for presentation to the user, collects click information, tracks each ad displayed back to its supporting information items all the way to the contributing fact furnishers, updates the corresponding fact furnisher accounts accordingly and reports them back on a timely basis to a central accounting database 16.

The components of the system are connected through communication network 300 such that the system can include a plurality of computing environments, which in turn can support a plurality of user devices and servers. For example, profile feeder 14, ad selector 8, and personal ad manager 10 reside on a single server 304. Alternatively, each program resides on different servers 304(n). The production of the actual content to be displayed as the advertisement message and of the corresponding billing reports to the advertiser system manager makes use of an external media store according to the art known to the skilled software programmer.

In one embodiment, the system incorporates an extensible list of formal definitions for the user profile information items that compose the user profile. These definitions are shared by all suppliers of user profile information 301(n), to identify the information items each supplier provides profile feeder 14 for inputting into the user profile, and by all advertisers 1(n), to identify the facts on which to base the criteria used by the ad selector 8 to target advertising messages to the appropriate user profiles.

In one embodiment, the system recognizes the possibility for a user profile over time to receive the same information item, within some consistency margin, from multiple suppliers. Ad selection criteria can make reference to the existence and number of such reinforcing multiple sources to weigh the likelihood of an information item. The profile feeder 14 and the personal ad manager 10 account for all suppliers that have contributed to the same information item each time the presentation of an advertisement is based on this information item.

In another embodiment, the system recognizes the possibility over time for a user profile to receive multiple inconsistent information items from suppliers, in particular when several persons share the same user access to the advertising system. The system maintains a list of consistency rules which profile information items can reference and the profile feeder 14 can use to decide whether two values for the same information item are consistent. Advertisement selection criteria can make reference to the existence of multiple inconsistent values to discount the likelihood of an information item. The ad selector 8 and the personal ad manager 10 take into account the specific value the ad selector 8 used to satisfy an advertisement selection criteria among possible values of a supporting information item.

In another embodiment, the system recognizes some user profile values change overtime in a completely predictable way, for instance when information items measure an age or other time span. The system maintains a list of updating rules which profile information items can reference and the profile feeder 14 can use to keep all information items up-to-date once they have been provided by suppliers.

In another embodiment, the system recognizes that information items that compose the user profile may become suspect, i.e., out of date or no longer material to the user, with the passage of time. The system attaches an expiration date to information items provided by suppliers. Suppliers may extend the validity of an information item by refreshing this information item via the profile feeder 14. Ad selection can make reference to the current validity status of the information items at the time selection criteria are applied.

In another embodiment, the system allows suppliers to gain exclusivity over providing an information item to the user profile in exchange for posting of a bond. The profile feeder 14 enforces the exclusivity, which lapses if the value is found to be past its expiration date. Advertisement selection criteria can make reference to the existence of a bond to weigh the likelihood of an information item value.

In another embodiment, the system allows advertisement selection criteria to make reference to the accounting figures kept by the personal ad manager 10 on a supporting information item to weigh the effectiveness of this information item.

In another embodiment, the system allows advertisers 1 to specify presentation rules that the personal ad manager 8 applies to determine which personalized advertisement to pick for display at the request of an advertising space seller 6. The presentation rules can refer to the accounting figures kept by the personal ad manager 10 on the corresponding advertisement and to context information provided by the advertising space seller 6. Whenever several personalized advertisements are found to be suitable for display, the personal ad manager 8 may further pick the one that satisfies some objective of the advertising system manager, such as expected revenue maximization.

In another embodiment, the system allows the advertising system manager to vary the price charged the advertiser based on the complexity of the advertisement selection. Whenever the personal ad manager 10 picks an advertisement for display, the personal ad manager 10 reports the total number of information items that the ad selector 8 used when it applied the selection criteria of this advertisement against the user profile.

In another embodiment, the system does not rely on the user's interacting with an external source in order to display personalized advertisements in an interstitial mode but provides the advertisements instead according to the request of the computing environment, for instance as a screen saver.

Another general aspect of the invention herein provides an embodiment in which the system maintains the confidentiality of the user profile against any entity other than the user. As a consequence, the information items provided by the plurality of suppliers are collected inside the user profile and no entity is granted access to any of the information items or to a copy thereof, thus becoming a data aggregator. The user profile, the personalized ad store and a local version of the fact furnisher accounts are placed within a security wall, i.e., a confidential, personalized and interactive environment, such as fully described in U.S. Pat. No. 6,092,197.

Referring to FIG. 2 which shows a block diagram of an embodiment of the system showing different components of the profile-based targeted advertising system accounting for input from a fact furnisher in which the system is configured to provide a high level of user privacy. The three applications, profile feeder 14, ad selector 8 and personal ad manager 10, run from one or more client devices 302(n) within confidential environment 18, and are thus prevented from communicating any information to any entity other than the user to the exception of the furnisher account reports to the central accounting database 16 and references to the content of the advertisements themselves provided to an external media store in response to ad display requests. Advertisement related information is used solely within the computing environment to present the advertisement to the user, with the exception of communications for billing and media content retrieval purposes.

In yet a further embodiment, the communications between the computing environment and the external media store are mediated through a proxy server, which prevents the entity controlling the external media store from linking together the stream of advertisements actually presented by the advertising system to the user and thus reconstructing some approximation of the user profile in violation of the user's privacy.

In another embodiment, the system allows advertisers to specify reusable profile targeting rules separately from the advertisements aimed at these targets. The ad selector 8 receives these selection templates and stores them within the computing environment so that advertisements can make reference to them in lieu of carrying an explicit list of selection criteria.

In another embodiment, the system allows for statistics to be compiled over specific profile targets. Given a target already described by a selection template, the advertising system manager can send an advertisement referencing this template, limited by its presentation rule to no more than one display during the period assigned to gather the statistics and carrying an empty message whose delivery is invisible to the user. Billing reports for this pseudo advertisement reveal the total number of active users within the target.

In another embodiment the system provides for an individual user to secure the profile maintained on the one or more client devices 302(n). In another embodiment, the system provides for a user who has secured their profile to allow or disallow suppliers.

In another embodiment, the system allows a user who has secured their profile to view its content, including for each information item, the name and contact information of the supplier that provided an information item or that provided the rule which derived the information item. Whenever an error has been made, the real user may apply for redress by contacting the supplier or, if the supplier is bonded, by asking the advertising system manager to arbitrate the dispute.

In one embodiment, the system provides for a user who has secured their profile to edit its content by deleting or adding information items, to the exception of information items from bonded suppliers.

In another embodiment, the system allows a user who has secured their profile to edit and post a filter describing the preferences of the user relative to advertisements. The advertising system manager uses the filter to send the ad selector 8 only those advertisements that satisfy the user filter. User filters may be constrained to be a user variation of a generic template designed to ensure a real user cannot reject advertising to an extent that would be economically unsustainable to the advertising system manager.

The foregoing and other objects, features, and advantages of the invention will become apparent from the following, more particular description of certain embodiments according to the invention, as illustrated in the accompanying drawings.

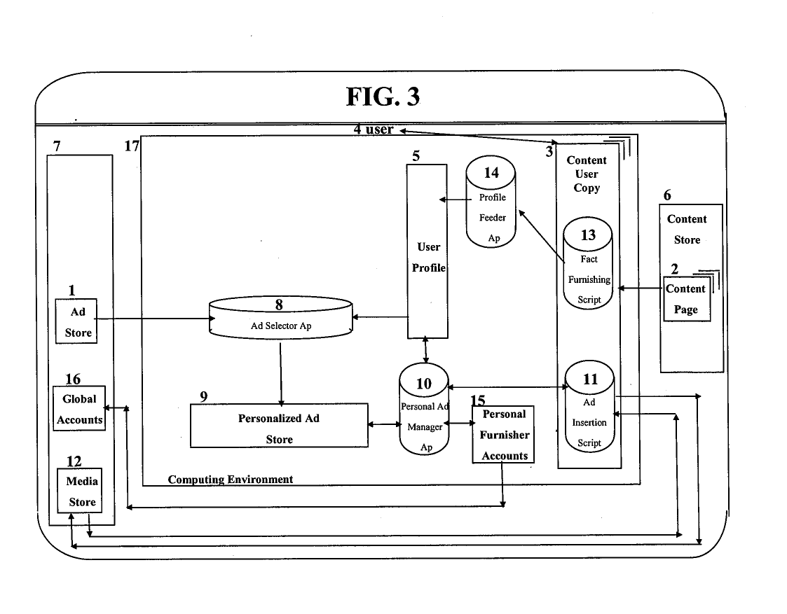

Referring now to FIG. 3, shown is a block diagram of a system according to one embodiment of the invention for accounting for input from a supplier of user profile information into a user-profile targeted advertising system. This system is described, for purposes of illustration only, as being implemented on a software programmable personal computer system using an object-oriented programming language, such as Sun Java, and connected to the Internet. It is to be appreciated that the present invention can be implemented in the context of other networks such as, for example, wide area networks WAN, local areas networks LAN, intranets, cellular phone networks, cable television networks, and also on any computer or programmable hardware known to hardware designers skilled in the art such as, servers, personal digital assistants, cellular phones, set-top boxes, game consoles. It will also be appreciated that the present invention can be implemented using other computing languages known to software programmers skilled in the art.

As shown, the advertising system presents targeted advertisements, i.e., message from ad store 1 in the context of one or more content pages 2 (the inverted L shapes in the upper right corner of content page 2 are the inverted L shapes that are referred to in the brief description of the drawings and indicate that content page 2 is one or more content pages) locally presented as copies 3 to a user 4. The existence of a user profile 5 specific to user 4 allows content provider 6 to sell space to the advertising system manager 7 for the purpose of personalized advertising. According to such a system, advertisements from the ad store 1 are sent to the ad selector application 8 to be selected on the basis of user profile 5 of user 4 and put in the personalized ad store 9 that is specific to user 4. The personal ad manager application 10, retrieves the advertisement from the personal ad store 9 in response to a request by some ad insertion script 11 associated with one or more pages 3.

Advertisements in ad store 1 and personalized ad store 9 have a unique reference reported by the ad insertion script 11 to the media store 12 for billing purposes. When the size of individual advertisements is significant, as for example with advertisements having graphics, pictures and video, the unique reference is further used by the ad insertion script 11 to retrieve the final message from the media store 12 for presentation to the user 4. While the present invention is described according to the conventions of interstitial advertising, page 2 does not need to have actual content and does not need to have been actively solicited by user 4, as long as copy 3 is called upon to present the advertisement to user 4.

The present system also provides that an interaction by user 4 with content provider 6 can be used at the initiative of content provider 6 to establish one or more information items about the user. For example if page 2 is the confirmation for attendance to a concert by the Boston Symphony Orchestra (BSO), content provider 6, whether the BSO itself or a ticketing agency, can assume user 4 has an interest in classical music. In another example, content provider 6 may be an insurance company that maintains a database containing the birth dates of its customers. If the identity of user 4 has been established by the insurance company earlier in the interaction with this user, this company can decide to report in page 2 as a known information item that user 4 was born in 1972. The present invention therefore provides local copy 3 of page 2 to hold some fact furnishing script 13 that interacts with profile feeder application 14 to input the corresponding information item or items into user profile 5, such that content provider 6 uses the fact furnishing script 13, when acting as a supplier of user profile information.

The software programmer skilled in the art will understand that the systems herein provide that content provider 6 can be a space seller, a supplier of user profile information, or both. The role of content provider 6 depends on different interactions with the user or simultaneously via the same page 2. For example the BSO might approve selling advertising space on the same ticketing confirmation page used to provide an information item about interest in classical music.

The system of the invention also accounts for a scenario in which there is a plurality of content providers 6, acting severally over time to fill up user profile 5. To motivate content provider 6 to act-as a supplier of user profile information, the advertising system maintains personal supplier accounts 15. Module 15 records how information items: are entered into user profile 5 by each content provider 6, when content provider 6 is acting as a supplier of user profile information through fact furnishing script 13; are used by the ad selector application 8 to select those advertisements that are ultimately presented to user 4 by personal ad manager application 10; and to what effect. Accounts maintained in module 15 relative to the user 4 are collected by the advertising system manager and stored in global accounts 16, allowing for account aggregation over a plurality of users 4.

Ad selector 8, personal ad manager 10, and profile feeder 14 are running within some computing environment 17. Computing environment 17 also includes content user copy 3, user profile 5 and personalized ad store 9. In one embodiment, the computing environment is a cellular phone supporting a single user 4 and the advertising system supports a plurality of such computing environments. In another embodiment, the computing environment 17 itself supports a plurality of users 4 in successive sessions, as on a personal computer with multiple login accounts. In yet another embodiment, the computing environment 17 may be distributed over several machines, for instance a server and its clients, as when a plurality of users 4 having local portable digital assistants are simultaneously logged-in to a remote central server. Whenever computing environment 17 is distributed, it is preferable that content user copy 3 be located on the local hardware of user 4.

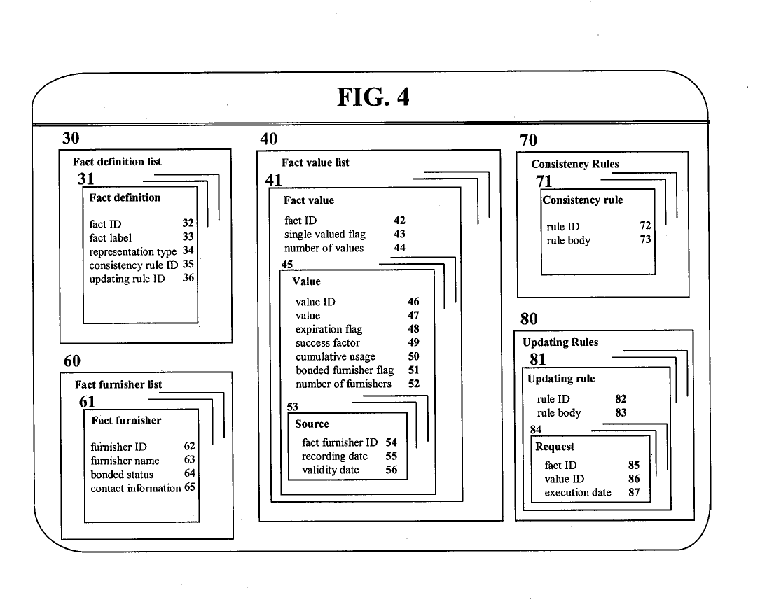

Referring then to FIG. 4, shown are the major components used by the profile feeder application 14 to manage user profile 5 according to an embodiment of the present invention. Data structure 30 holds the definition of the facts recorded in user profile 5. For each fact 31, fact definition list 30 contains a record made of unique fact ID 32, fact label 33, and representation type 34. In certain embodiments, fact definition list 30 also includes consistency rule ID 35 and updating rule ID 36.

Fact definition list 30 allows advertisers responsible for the selection criteria used by advertisements stored in ad store 1, and suppliers responsible for supplying information items via fact furnishing script 13, to agree on how ad selector application 8 and profile feeder application 14 can share access to user profile 5. While the software programmer skilled in the art can devise different collaboration schemes to achieve such an agreement, a simple method is for the advertising system manager to define and publish a version of the fact definition list 30 and to mandate its use by all participants. This formal list can be defined incrementally over time. The list can also be segmented into multiple nested domains of interest, including for example a domain for leisure activities with such items as “interested in bicycle riding” or “interested in classical music”, and a domain for professional activities with a sub-domain such as “software programming” with such items as “advanced Java programming ability” or “development project managing skill”. In one embodiment of the present invention, this formal list is derived from and compatible with, “domain vocabularies” described in U.S. Pat. Application No. 2006/0053279, which is hereby incorporated by reference herein in its entirety.

Fact ID 32 is used for internal reference purposes while fact label 33 is used for presentation to a human reader. Representation type 34 allows the advertising system to efficiently manage different data types such as dates, numbers, lists of choices as described for instance in U.S. Pat. Application No. 2006/0053279.

In certain embodiments, the system of the present invention does not involve much user participation. In one embodiment, the advertising system does not require user 4 to uniquely identify himself or herself.

The system of the present invention recognizes that user 4 is not always the same individual, that the profile of a single individual may vary over time, and that a plurality of independent fact furnishers are bound to disagree from time to time even when dealing with a consistent individual. The system accounts for the fact that different values may be provided for the same information item relative to the same user profile 5 by providing consistency rule ID 35, which allows for profile feeder application 14 to decide whether two different values are the same information item, within an acceptable error margin. For example, if user profile 5 already contains an information item “monthly gross income” equal to “US $8,450” and a new instance of the fact furnishing script 13 provides a value of “US $9,500”, the consistency rule associated with this information item may decide that the two values are compatible. In contrast, if user profile 5 already contains an information item “sex” equal to “male” and a new instance of fact furnishing script 13 provides a value of “female”, the consistency rule associated with this information item decides that the two values are different.

Several facts 31 can have the same consistency rule ID 35. For example a specific rule that states that two numerical values reflect the same value within a 50% relative range, and different values above that, may apply for instance to such facts as “commuting distance” or “number of meals at a restaurant per year”. Another specific rule that states that two numerical values reflect the same value within a 15% relative range, and different values above that, may apply for instance to such facts as “age” or “income”. Yet another specific rule can state that two different choices relative to the same closed list expecting a single choice are different.

Further, the system recognizes that certain information items vary with time in a predictable manner. For example, if user profile 5 contains an information item “age equal to 35”, the system recognizes and accounts for the fact that this information item will change to “age equal to 36” one year later. The system accomplishes such tasks by referring to updating rule ID 36. In certain embodiments, several facts 31 share the same updating rule ID 36. For example, a specific rule may mandate a numerical value to be updated every year by incrementing it by one, and applying such a rule to facts such as “age” or “age of cars in household”. Another rule may mandate a numerical value be updated every month by decreasing the value by one every month until the value is equal to zero, such as with information item “new car purchase intention” expressed in months.

In certain embodiments, several users 4 share computing environment 17 through a single client device. In such embodiments, fact definition list 30 is common to the users of that client device. On the contrary, data structure 40, the fact value list, is specific to each user 4 and resides within the user profile 5. Whenever the profile feeder application 14 receives a specific fact about the user 4, profile feeder 14 creates or updates entry 41 in fact value list 40 to hold the corresponding value. Fact value 41 records the relevant fact ID 42, single valued flag 43, number of values 44 and, for each different value, a record 45 of the specific value. Fact value 41 is designed to accommodate an inconsistency in user profile 5 that may have been detected, as described above, by consistency rule 35 associated with fact definition 31 that has fact ID 32 equal to fact ID 42.

Single valued flag 43 is set to “on” by default, and is turned “off” if consistency rule 35 detects an inconsistency. In certain embodiments, an advertiser may wish to instruct ad selector application 8 to refuse selection for a specific advertisement in ad store 1 if the advertisement depends on fact value 41 and single valued flag 43 associated with value 41 being set to “off”.

Alternatively, for another specific advertisement in ad store 1, a more aggressive advertiser may decide to let ad selector application 8 ignore the value of flag 43. For example, user 4 may stand for a husband and a wife sharing the same personal computer, and it may be advantageous to expose one member of the couple to advertising targeted for the other member. For instance, the advertisement may be for a vacation package to France and formally fits the interests of the wife and not the husband, although the husband is likely to be involved in the decision.

Number of values 44 is set to zero by default. Each time the profile feeder application 14 creates a distinct value entry 45, it increments number of values 44 by one. Each time the personal ad manager application 10 deletes a distinct value entry 45, for example because the value has expired, ad manager application 10 decrements number of values 44 by one. Whenever number of values 44 goes from two to one, it resets single valued flag 43 to “on”, i.e., the default setting. Number of values 44 can be put to a use similar to single valued flag 43 with respect to advertisement selection. The higher number of values 44, the higher the risk of making an erroneous assumption on the real user while selecting an advertisement on the basis of fact value 41. In certain embodiments, the advertisement system manager imposes a system-wide limit to number of values 44 beyond which it is neither practical nor useful to record inconsistencies.

Value entry 45 in fact value entry 41 contains value ID 46, value 47, expiration flag 48, success factor 49, cumulative usage 50, bonded furnisher flag 51, and number of furnishers 52. Value entry 45 also includes for each fact furnisher, i.e., supplier of user profile information items, a record 53 that holds the parameters that characterize the corresponding source, namely fact furnisher ID 54, recording date 55 and validity date 56. For a specific information item, each value ID 46 is unique, and when appended to the corresponding fact ID 42, makes for a unique reference for the corresponding actual value 47 assigned to user profile 5.

Expiration flag 48 is set to “off” by default. Expiration flag 48 signals when the validity dates 56, as recorded in source entries 53, are past, but value entry 45 as a whole has not yet been deleted by the personal ad manager application 10. The profile feeder application 14, is responsible for setting expiration flag 48 to “on” during a repeated sweep, e.g. daily, over the entries in fact value list 40. The profile feeder application 14 is also responsible for resetting expiration flag 48 to “off” whenever profile feeder application 14 collects an up-to-date information item from a supplier through fact furnishing script 13.

Number of fact furnishers (suppliers of user profile information) 52 is zero by default. The profile feeder application 14 increments counter 52 each time it collects a new source 53. Personal ad manager application 10 decrements number of fact furnishers 52 each time Personal ad manager application 10 deletes a source 53 found to be past its validity date. Personal ad manager application 10 also deletes value entry 45 altogether whenever number of fact furnishers 52 resets to zero.

Success factor 49 is set to 100 and cumulative usage 50 is set to 0 by default. The personal ad manager application 10 manages current values of success factor 49 and cumulative usage 50. Cumulative usage 50 reflects the number of times advertisements presented by the personal ad manager application 10 have taken value 47 for fact ID 42 into account. Success factor 49 reflects the percentage of these presentations that have lead user 4 to click-through the presented advertisement.

Fact furnishing, i.e., providing user profile information items, is generally divided into two categories, common or bonded. To supply a bonded user profile information item, the supplier who had issued associated user copy 3, must have posted a bond or an equivalent security and agreed to submit to some “redress process” supervised by the advertising system manager. For example, an online store that processes credit card purchases may become a bonded supplier of user profile information, and provide bonded information items that directly reflect the type of purchases made by users. Multiple purchases on the same credit card of children clothing articles in specific sizes during back to school sales provides a rather accurate picture of the children present in a household, a very useful information item for advertisers in the toy industry in the last quarter of the year.

In another embodiment, the system provides the bonded supplier of user profile information the opportunity to bond each subsequent information item it provides to the system. In embodiments that include a bonded supplier, the profile feeder application 14 limits the value entry 45 to hold only one source 53 for the duration of its validity. When profile feeder application 14 encounters a bonded source and bonded furnisher flag 51 is “off”, the default value, profile feeder application 14 invalidates past unbonded suppliers and the associated source entries 53 of these suppliers by bumping the associated validity date 56 of these suppliers to the current time, and turning bonded furnisher flag 51 “on”.

Profile feeder application 14 then refuses to consider sourcing of the same information item from any other supplier of user profile information until the validity date 56 of the bonded source 53 expires. The exclusivity to the supplier of the bonded information item can be extended by the currently bonded supplier if the supplier presents profile feeder application 14 with a consistent value entry 45 at a later time that is prior to the validity of the bonded information item expiring. The profile feeder application 14 performs repeated validity sweeps over entries 45 in fact value list 40 to check for ongoing validity of the bonded information item by comparing validity date 46 for the bonded information item with the current time. If profile feeder application 14 determines entries 53 are past validity, profile feeder application 14 sets expiration flag 48 to “on” and resets bonded furnisher flag 51 to “off”.

If there is no bonded supplier of user profile information in the source list held by value entry 45, and the new source to be recorded is not bonded, the profile feeder application 14 checks pre-existing entries 53 to verify if the supplier is already known, based on the unique fact furnisher ID passed by the fact furnishing script 13. If the supplier is new, profile feeder application 14 creates a new source entry 53, listing fact furnisher ID 54, together with current date 55, and expiration of validity date 56. The profile feeder application 14 also increases the value of number of furnishers 52 by one.

The value of validity date 56 is determined by the advertising system manager, either on a system-wide basis or depending on the fact definition 31 whose fact ID 32 equals fact ID 42. If the supplier of user profile information is already listed as a source entry 53, profile feeder application 14 updates recording date 55, and extends validity date 56 of existing source 53 accordingly. This provides an incentive for suppliers to refresh their information. In certain embodiments, the advertising system manager limits the total number of current suppliers for any given fact value 45 to some maximum, for instance five. Getting an information item from multiple independent sources offer advertisers extra confidence. On the other hand, the lower this maximum, the more beneficial it is for the listed supplier of that information item. In embodiments in which the advertising system manager sets a maximum, profile feeder application 14 ignores new suppliers for value entry 45 whenever the number of furnishers 52 is equal to the set limit.

Advertisers may instruct the ad selector application 8 to consider the inconsistency of a fact value 41 on which it bases its selection, as reflected by single valued flag 43 and number of values 44. Similarly, advertisers may include in criteria, i.e., further characteristics, of value entry 45 whose value 47 satisfies the condition put on fact value 41. Such criteria include recency (according to expiration flag 48), likelihood (according to either bonded furnisher flag 51 or number of furnishers 52), and effectiveness (according to success factor 49 and cumulative usage 50). The system of the present invention provides a high level of freedom to suppliers of user profile information to provide as much information as practical, and to advertisers to determine whether to avail themselves of this information.

Ancillary structures 60, 70 and 80 increase the efficiency of profile feeder application 14. Structure 60 contains the active suppliers of user profile information, i.e., fact furnishers, in computing environment 17, for each such fact furnisher 61, listing its unique furnisher ID 62, its name 63, bonded status 64, and fact furnisher contact information 65 in case redress needs to be sought. Structure 70 contains the consistency rules associated with the fact definition list 30, for each such consistency rule 71, listing its unique rule ID 72 and its rule body 73. Structure 80 contains the updating rules associated with fact definition list 30, for each such updating rule 81, listing its unique rule ID 82, its rule body 83 and a request list, for each update request 84, listing the target fact ID 85, the value ID 86 and the execution date 87. Whenever several users 4 share a single client device in computing environment 17, fact furnisher list 60 and consistency rule list 70 apply to all. Data structure 80, the updating rule list, containing update requests specific to each user 4, resides in user profile 5. In another embodiment, data structure 80 can be split between a user independent part without the request lists, and a user dependent part in which the rule bodies are replaced with appropriate references to the user independent part.

When profile feeder application 14 creates a new value entry 45, the application checks the relevant fact definition entry 31 in fact definition list 30, whose fact ID 32 equals fact ID 42, to see if an updating rule applies as determined by updating rule ID 36. If an updating rule applies, profile feeder application 14 creates a new request entry 84 for updating rule 81 whose rule ID 82 equals rule ID 36, listing fact ID 42 and value ID 46 as respectively fact ID 85 and value ID 86. The application further extracts the interval after which the next update should take place from rule body 83, and records this value as execution date 87. For example, if the value “34” is recorded for fact “age” on Aug. 15, 2007, an execution date of “08/15/08” will be entered at which to increment “age” by one after an interval of one year.

Profile feeder application 14 repeatedly scans the entries in fact value list 40 to sweep requests in updating structure 80, requests execution of update rules which are due, and computes the next execution date 87. Examples of rules can be found in U.S. Pat. No. 6,092,197, which is hereby incorporated by reference herein in its entirety. The software programmer skilled in the art will easily apply this and other formal declarative methods to the special cases of consistency rule 71 and updating rule 81.

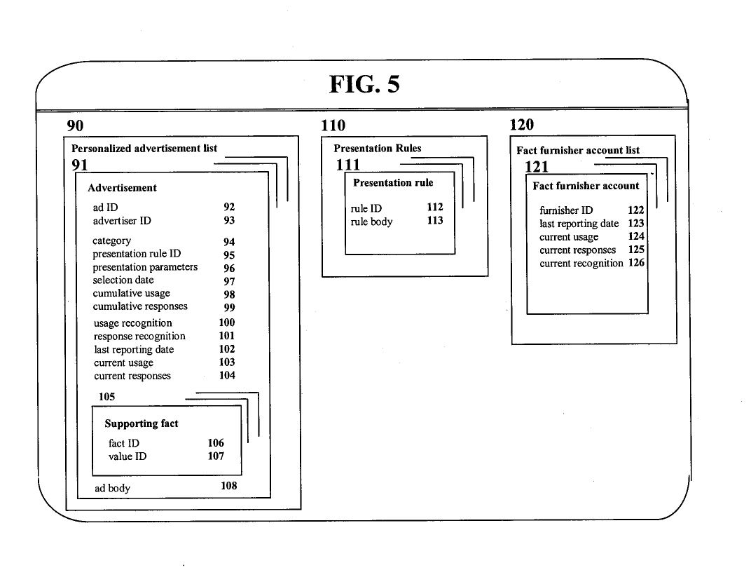

Referring now to FIG. 5, shown are the major components used by personal ad manager application 10 to manage the personalized ad store 9 and the personal furnisher accounts 15 according to one embodiment of the present invention. Data structure 90 holds the information for the advertisements selected by the ad selector application 8 for the user 4 based on user profile 5, and put inside personalized ad store 9. For each such advertisement 91, personalized advertisement list 90 contains a record of unique ad ID 92, unique advertiser ID 93 and information to present the advertisement to user 4 and to account for the participation of suppliers of user profile information in making such presentations possible.

The system of the present invention allows advertisers to manage the presentation of an advertisement, once selected for a particular user, with a high level of freedom. To this effect, for each advertisement 91, advertisers are able to specify category 94 of the advertisement, referring to a classification scheme for domains of interest, and presentation rule ID 95, together with parameters 96. The ad selector application 8 records selection date 97, i.e., the date at which ad selector application 8 selected advertisement 91 as appropriate for user 4. The personal ad manager application 10 also records cumulative usage 98, i.e., the total number of times personal ad manager application 10 picks advertisement 91 for presentation to user 4 via ad insertion script 11. The personal ad manager application 10 also records cumulative responses 99, i.e., the total number of times user 4 clicks on the advertisement 91. Counter 98, for presentations, is initialized to zero and incremented by one according to the decision of personal ad manager application 10. Counter 99, for click through's, is initialized to zero and incremented by one by the personal ad manager application 10 according to information relayed back by ad insertion script 11.

Presentation rule ID 95 references presentation rule list 110 that contains rule ID 112 and rule body 113 for each presentation rule 111. For example, an advertisement may be presented to user 4 at one week intervals starting from the advertisement selection date 97, “9/10/07”, whenever the context established by content page 2 and communicated via ad insertion script 11 is suitable for category 94 “children toys” and the time of the presentation falls between “10/13/07” and “12/21/07” (as included in 96) until either the cumulative usage 98 reaches 10 or the user responds to the advertisement by clicking on it (cumulative responses 99 reaches 1). Examples of rules can be found in U.S. Pat. No. 6,092,197. The software programmer skilled in the art will easily apply this and other formal declarative methods to the special cases of presentation rule 111.

In one embodiment of the present invention, the advertisement body is recorded as 108 in advertisement 91. In another embodiment, the advertisement body is not recorded and personal ad manager application 10 passes ad ID 92 and advertiser ID 93 to the ad insertion script 11 for the script to use as a reference when retrieving the advertisement body from the media store 12. Even if the ad insertion script 11 receives the advertisement body directly from personal ad manager application 10, the insertion script still communicates ad ID 92 and advertiser ID 93 to the media store 12 for billing purposes.

The advertising system manager is responsible for setting two rates, usage recognition rate 100 and response recognition rate 101. Together, these rates recognize the participation of suppliers to the selection and the presentation of advertisement 91 to user 4. In one embodiment, these rates depend on advertisement 91. In other embodiments, these rates can be chosen according to many different schemes, for example, depending solely on category 94, or depending on advertiser ID 93, or fixed on a system-wide basis. Nothing in the present invention constrains the unit in which they are expressed, be it a real currency, like the US dollar or a fraction thereof, a virtual currency, like redeemable points, or any other unit which potential fact furnishers will consider incentive enough.

The ad selector application 8 is responsible for the creation and initialization of the advertisement entry 91. This includes initializing last reporting date 102 to the date of creation of advertisement 91, initializing current usage 103 and current responses 104 to zero, and setting a list of the information items that were used to select advertisement 91, including fact entry 105, comprising fact ID 106 and value ID 107. Together, fact ID 106 and value ID 107 uniquely identify the user profile value entry 45 taken into account. In one embodiment, the advertising system manager requires advertisers to base their selections on a maximum number of fact value entries 45, for example 20 entries. The personal ad manager application 10 further manages current usage 103 and current responses 104 so that whenever it increments counter 98, respectively 99, by one, it also increments counter 103, respectively 104.

Date structure 120 holds the fact furnisher account list inside personal furnisher accounts 15. Each such fact furnisher account 121, created by the profile feeder application 14 each time a new supplier is created in the fact furnisher list 60, contains fact furnisher ID 122, last reporting date 123 initialized to the time of creation, current usage 124, current responses 125 and current recognition 126. Current usage 124, current responses 125, and current recognition 126 are initialized to zero.

At intervals that do not have to be strictly periodic in order to take into account the availability of computing environment 17, personal ad manager application 10 makes an accounting sweep of the advertisements 91 recorded in advertisement list 90. For each advertisement entry 91 and each supporting fact 105 for advertisement entry 91, personal ad manager application 10 looks-up the fact value list 40 for each corresponding fact value entry 45, with fact ID 42 equal to fact ID 106 and value ID 46 equal to value ID 107. Personal ad manager application 10 then adds the value of current usage 103 to the old value of the cumulative usage 50 to determine the new value of cumulative usage 50, and update the success factor 49 according to the formula:

new success factor 49=100((old success factor 49*old cumulative usage 50)/100+current responses 104)/new cumulative usage 50.

Personal ad manager application 10 further looks-up the number of furnishers 52 and sources listed for the fact value 45, and for each such said source entry 53, uses the fact furnisher ID 54 to locate the corresponding fact furnisher account 121 that has furnisher ID 122 equal to fact furnisher ID 54 inside fact furnisher account list 120. Personal ad manager application 10 then adds the current usage 103 to current usage 124, and also adds current responses 104 to current responses 125. Personal ad manager application 10 also updates current recognition 126 by incrementing it by the following amount:

(usage recognition 100*current usage 103+response recognition 101*current responses 104)/(number of supporting facts*number of furnishers 52);

where the number of supporting facts is the number of the records 105 for the advertisement 91.

Once personal ad manager application 10 finishes with a specific advertisement 91, personal ad manager application 10 reinitializes the last reporting date 102 to the current time, and resets counters 103 and 104 to zero. The software engineer skilled in the art will appreciate that for each fact furnisher account 121, current usage 124 and current responses 125 measure how many advertisement presentations, and how many user reactions supplier of furnisher ID 122 has influenced overall. Similarly, current recognition 125 measures how much this influence has been rewarded by the advertising manager, according to its current policies and taking into account the contribution of other suppliers to the same information item as provided by supplier of furnisher ID 122. The advertisers skilled in the art will further appreciate that more complex formulas can be used in other embodiments of the present invention to compute the recognition of a supplier from the user profile information items that link the values contributed by the supplier to user profiles, according to a logical chain of evidence, to the revenues generated by personalized advertising based on the profiles.

At the end of each accounting sweep, three measures have been computed to account for supplier input for advertisements 91 presented to user 4 and fact values 45 material to the selection of the advertisements. Each accounting sweep is followed by a cleaning of fact value list 40 of user 4, during which the personal ad manager application 10 eliminates source entries 53 past the validity dates and value entries 45 devoid of a single valid supporting source. The software engineer skilled in the art will appreciate that the embodiment thus described effectively extends source validity dates until the date of the next accounting sweep.

The more frequent the accounting sweeps by the personal ad manager application 10, the less the distortion on fact furnisher accounts in list 121 as well as on number of values 44 and number of furnishers 52. In another embodiment, the operating systems in computing environment 17, responsible for executing personal ad manager application 10 and profile feeder application 14, schedule an accounting sweep by personal ad manager application 10 followed by a validity sweep by the profile feeder application 14 on a regular daily basis or as soon thereafter as computing environment 17 becomes available, to better eliminate distortions. Scheduling an independent accounting sweep allows personal ad manager application 10 to focus on the presentation of advertisements. In another embodiment, each time personal ad manager application 10 picks advertisement 91 for presentation, personal ad manager application 10 immediately accounts for this action back into the fact furnisher account list 120, and the profile feeder application 14 cleans-up fact value list 40 during a validity sweep.

At other intervals, the personal ad manager application 10 makes a reporting sweep over fact furnisher accounts in list 120, and for each account 121, reports content of the account to global accounts 16, managed by advertising system manager 7. After each reporting of account 121, last reporting date 123 is reset to the date of the reporting, and counters 124, 125 and 126 are reset to zero.

The present invention does not constrain how the ad selector application 8 utilizes profile 5 of user 4 to select advertisements the ad selector application 8 receives from ad store 1 to be put in personalized ad store 9 that is specific to user 4. In one embodiment, ad selector application 8 is activated whenever the computer environment 17 is running, and ad selector application 8 receives a stream of advertisements that are broadcast from ad store 1. Each such advertisement includes a message body, which can be replaced by a simple reference to a collection of bodies held in media store 12, and a selection criteria that is chosen by the advertiser to be matched against user profile 5. U.S. Pat. Application No. 2006/0053279 gives a detailed description of how to design such selections criteria and implement ad selector application 8 to process the selection criteria. In one embodiment, the computing environment 17 is at any one time dedicated to a single user 4 and ad selector application 8 simply works with user 4 and associated profile 5 and personal ad store 9. In another embodiment, a server computing device communicating through the computing environment 17 contains information about a plurality of users 4, and ad selector application 8 is designed to loop over such users 4, active or inactive. When ad selector application 8 successfully finds an advertisement with selection criteria that are compatible with profile 5 of user 4, ad selector application 8 uses the ad ID to check in personalized advertisement list 90 whether the advertisement has already been selected. If the advertisement has not been previously selected, ad selector application 8 enters a new advertisement entry 91, recording as supporting facts 105 the facts used in the selection process, excluding meta information such as entries 43, 44, 48, 49, 50, 51 and 52 used to assess information quality.

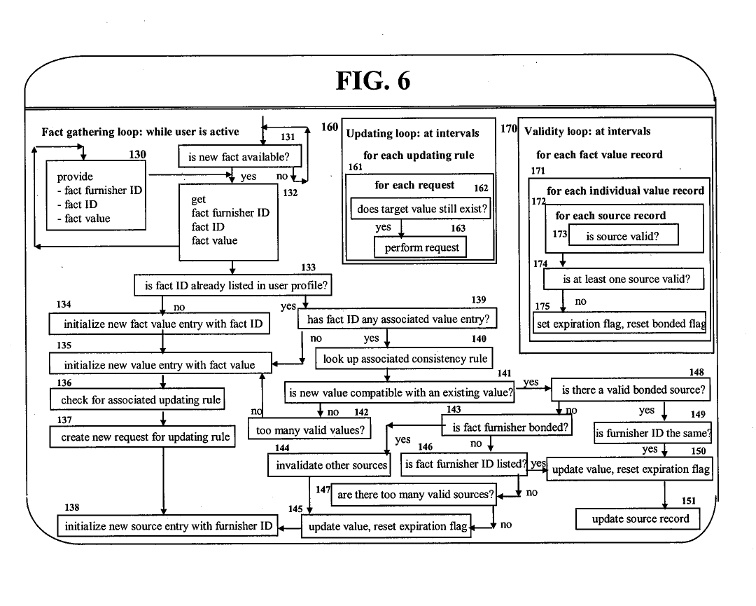

Referring now to FIG. 6, shown are the main steps describing how the profile feeder application 14 operates. An important responsibility of profile feeder application 14 is to enter information items into user profile 5 in response to prompting 130 from fact furnishing script 13. In one embodiment, this is implemented as an endless loop which starts by declaring its state of readiness (131) and waits until it receives a fact (132) from script 13, freeing script 13 in the process. Once profile feeder application 14 has dealt with the newly provided information item, the application returns to a state of readiness.

User profile information processing begins by checking if the user profile information item is already listed in fact value list 40 (133). If the user profile information item is not listed, steps 134-138 create appropriate entries 41, for the fact 45, for its value 53, and for its source. These steps also create request 84 if necessary for a future mechanical update. If the user profile information item is listed, step 139 checks for the presence of any outstanding entry 45, an embodiment that involves consistency analysis (140-141). If no past value is found to be consistent with the newly provided information item provided, and the maximum number of value entries 45 has not been reached (142), the processing continues with steps 135-138 as before.

If the information item provided is consistent with an existing value entry 45, profile feeder application 14 manages the potential conflicts created by a plurality of suppliers. If flag 51 indicates the presence of a bonded supplier (148), the system determines whether the supplier of the newly provided information item is the same bonded supplier or another supplier, bonded or unbonded (149). If the supplier is different, the supplier is dropped from further consideration by profile feeder application 14, which loops back to step 131, thereby enforcing the exclusivity of the bonded supplier. If the system determines that the information item is from the bonded supplier, profile feeder application 14 simply updates value entry 45, including value 47 and the corresponding source record 53, making sure expiration flag 48 is reset to “off” (150-151).

If there is no pre-existing bonded supplier, profile feeder application 14 checks whether the supplier behind the newly provided information item is not itself bonded (143), in which embodiment other pre-existing values are invalidated (144) before value entry 45 is updated, including value 47, bonded furnisher flag 51 and expiration flag 48 (145), and a new entry 53 is created since this bonded supplier is new (138). If no bonded supplier is involved, profile feeder application 14 checks to see if the supplier behind the newly provided information item is already listed as a source (146), leading again to a simple update (150-151), and if the maximum number of independent sources is not exceeded (147), to an update (145) with new source creation (138).

In addition to this main loop, profile feeder application 14 is scheduled by the operating system responsible for executing profile feeder application 14 in the computing environment 17 to perform two sweeps at repeated intervals over user profile 5.

The first sweep is to maintain recorded values up-to-date according to the update requests 84. Updating loop 160 reviews each updating rule to look at each request (161). When a request is due, profile feeder application 14 checks whether the request has become invalid, which happens when the underlying fact value is itself past validity date (162). If the target value still exists, the request is performed (163). Software engineers skilled in the art know there exists a number of optimization techniques, for instance by pre-ordering requests 84 by date of execution, to dispense profile feeder application 14 from such an exhaustive review. In another embodiment, the application responsible for deleting a value entry 45 purges corresponding update requests 84.

The second sweep is to maintain validity information about fact values 45 for the benefit of advertisers. Since source entries 53 and fact value entries 45 contain information needed to account for suppliers' input, profile feeder application 14 cannot delete source entries 53 and fact value entries 45 arbitrarily once these values are past the validity date. Whenever profile feeder application 14 cannot find at least one valid supporting source 53 in fact value entry 45 (171-174), profile feeder application 14 sets expiration flag 48 (175). Profile feeder application 14 also uses the opportunity to terminate the exclusivity of any bonded supplier over an information item once past the validity date.

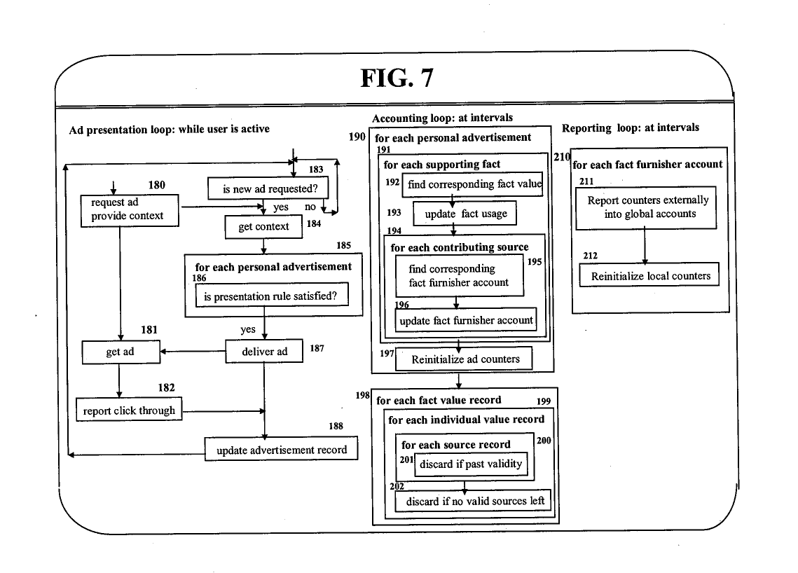

Referring now to FIG. 7, shown are the main steps describing how the personal ad manager application 10 operates. An important responsibility of personal ad manager application 10 is to provide a personalized advertisement from personalized ad store 9 in response to prompting 180 from ad inserting script 11. In one embodiment, this is implemented in an endless loop that starts by declaring its state of readiness (183) and waits until it receives the context describing a request (184) from script 11. The present invention does not constrain how to describe such context.

Advertisers and advertisement space sellers skilled in the art use parameters such as advertisement space formats, to agree on size and animation, content categories, e.g. to make certain advertisements appear next to travel-related content or to prevent certain advertisements from appearing next to controversial content, or content keywords, when the content is delivered in response to a search. Personal ad manager application 10 uses this context, augmented with the date and time of the request, to review personalized advertisement list 90 (185-186) until it finds an advertisement 91 whose rule of presentation 95 is satisfied by the context, given the ad category 94 and presentation parameters 96. In another embodiment, personal ad manager application 10 reviews the entire list 90 and chooses an advertisement that maximizes some objective criteria set by the advertising system manager. For example, the set criteria may be the expected value of the revenue received for a user click on the advertisement, computed as the product between the price bid for the advertisement (as included in 96) and the ratio of cumulative responses 99 to cumulative usage 98 (as measure of the probability of the next user click).

If personal ad manager application 10 fails to find a suitable personalized advertisement, any of a number of default actions are taken. For example, the advertising system may include non-targeted advertisement into ad store 1 and instruct ad selector application 8 to send personalized ad store 9 a non-targeted advertisement for personal ad manager application 10 to select. Alternatively, ad insertion script 11 may retrieve a non-targeted advertisement from another source. Software engineers skilled in the art know there exists a number of optimization techniques, for instance using pre-ordering by parameters such as selection date and price offered, to dispense personal ad manager application 10 from such an exhaustive review. As a result, personal ad manager application 10 delivers a suitable advertisement to script 11 (187), which receives the advertisement (181), reports the display request of the advertisement to media store 12 for, in one embodiment, getting the content of the advertisement and for billing purposes, presents the advertisement to user 4 within the context of content copy 3, and informs personal ad manager application 10 whether user 4 has clicked on the advertisement (182). The software programmer skilled in the art will appreciate that script 11 display request to media store 12 includes, as received from personal ad manager application 10 in step 187, ad ID 92 and advertiser ID 93. In another embodiment, script 11 also includes the number of supporting fact records 105 to allow the advertising system manager to vary pricing according to selection complexity.

The software programmer skilled in the art will further appreciate that whenever the advertising system manager bills advertisers on user click-throughs, ad insertion script 11 may be required to further report the click to the media store 12. In another embodiment, the advertising system learns from the click via the download request of the page called by this click. Personal ad manager application 10 increments cumulative usage 98 and current usage for the period 103 and then uses the click information provided in step 182 to determine whether to increment cumulative responses 99 and current responses for the period 104 (188). After incrementing, personal ad manager application 10 returns to a state of readiness.

In certain embodiments, two scans are scheduled by the operating system responsible for executing personal ad manager application 10 in the computing environment 17 to be performed at repeated intervals by personal ad manager application 10 over personalized ad store 9 and personal furnisher accounts 15. The first sweep accounts for the contribution of suppliers to the presentation of personalized advertisments. Accounting loop 190 looks at each personal advertisement 91 (191) and uses fact ID 106 and value ID 107 of each of supporting fact 105 to obtain the corresponding fact value entry 41 and fact value entry 45 (192). For value entry 45, personal ad manager application 10 updates cumulative usage 50 and success factor 49 based on the advertisement current usage 103 and current responses 104 (193). Personal ad manager application 10 further takes note of number of furnishers 52 and looks at each source 53 (194) to use fact furnisher ID 54 to obtain the corresponding fact furnisher account 121 (195). Having linked the personal advertisement record 91 and the account 121 of a contributor, personal ad manager application 10 proceeds to increment current usage 124 and current responses 125 respectively with the ad current usage 103 and current responses 104. Personal ad manager application 10 further updates fact furnisher account current recognition 126 based on the ad current usage 103 and current responses 104, given usage recognition 100, response recognition 101, and number of furnishers 52. Updating is performed according to the formula recited above or any other form as advertising system managers skilled in the art may choose, based on these and similar elementary pieces of information (196). Once supported facts 105 have been accounted for, personal ad manager application 10 reinitializes current usage 103 and current responses 104 to zero and start a new reporting period for ad 91 by setting last reporting date 102 to the current time (197).

Once the first sweep has finished recognizing the suppliers' contributions for the current period, a cleaning phase follows that retires sources and facts that are passed validity dates. Cleaning loop 198 goes over each fact value entry 41 and within it, each value entry 45 (199). For each source entry 53 (200), personal ad manager application 10 compares validity date 56 with the current date to determine whether the validity has expired. If the validity date has expired, personal ad manager application 10 deletes entry 53 and decrements number of furnishers 52 by one (201). If number of furnishers 52 reaches zero, personal ad manager application 10 deletes value entry 45 altogether (202).

The second sweep is to transmit the contents of fact furnisher account list 120 from personal furnisher accounts 15 to global accounts 16. Reporting loop 210 looks at each fact furnisher account 121 in list 120 and reports furnisher ID 122, current usage 124, current responses 125, and current recognition 126 (211). Each time an account is reported, personal ad manager application 10 reinitializes current usage 124 and current responses 125 to zero, and starts a new reporting period for account 121 by setting last reporting date 123 to the current time (212).

In certain embodiments in which the computing environment 17 supports a plurality of users 4, the validity sweep by the profile feeder application 14, and the accounting and the reporting sweeps by the personal ad manager application 10, are common to users 4. In particular, the reporting sweep sends global accounts 16 the value of counters 124, 125 and 126 for a given supplier only once per reporting period after the accounting sweep has accumulated in them the result of the activity of users 4.

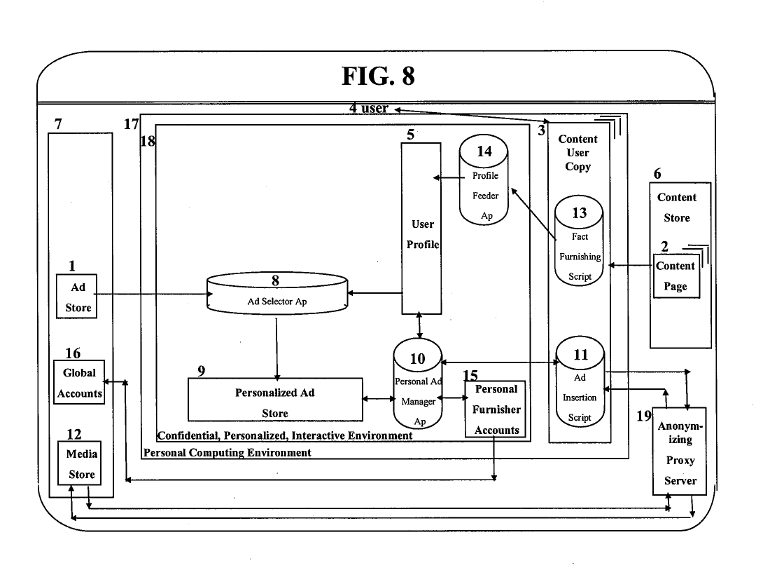

Referring now to FIG. 8, shown is an embodiment in which the advertising system can deliver a high level of privacy to user 4. This process involves restricting computing environment 17 to a local computing environment directly under the control of user 4, such as for instance a personal computer, a personal digital assistant, a cellular phone or a game console. The process further involves confining user profile 5, personalized ad store 9, and personal furnisher account 15 to a confidential, personalized and interactive environment 18, i.e., the programs operating within a security wall. Environment 18 is characterized by the ability to hold private information about one or a plurality of users, receive and store interactive applications from third parties, and allow the applications to use private information while maintaining privacy, i.e. that no piece of private information about the user is published to any one else. Such an environment is fully described in U.S. Pat. No. 6,092,197 and also in the corresponding European Patent Application No. 98935494.9.

In one embodiment described in U.S. Patent 6,092,197 and also European Patent Application No. 98935494.9, the confidential environment is located on the user computing device and in communication with a remote data processing system, and includes a discovery and exploitation rule engine operating with a knowledge base of dialog classes that have been transmitted by the remote data processing system and user related information items. The rule engine interfaces with the user and initiates prompts to the user, including prompts asking the user to reveal information items and to provide information enabling the rule engine to determine whether a revealed information item is to be published as a public information item that the user authorizes for publication to the remote data processing system, or a private information item that is not to be published. The rule engine stores in the knowledge base the information revealed by the user together with information indicating whether the information is to remain private or is to be published. The rule engine transmits to the remote data processing system only public information, and the rule engine processes both the private and the public information. Additionally, the rule engine can receive and store inbound public information made available from suppliers, and communicate outbound public information to suppliers.

The present invention uses such a remote data processing system to distribute the ad selector applications 8, the personal ad manager application 10, and the profile feeder application 14, to users as classes organized into dialogs to be run by the rule engine. The present invention also casts as public inbound information, information items provided to the profile feeder application 14 by fact furnishing script 13 (step 132), and further extend to such public inbound information items the protection described for user-provided private information items by having the profile feeder application 14, upon reception of a new information item, make a private copy and delete its public original. The present invention further restricts the ad selector applications 8, the personal ad manager application 10, and the profile feeder application 14 to use pure rules, which do not interact with the user.

The present invention also enforces consistency rule bodies 73, updating rules bodies 83 and presentation rule bodies 113 to be pure rules. The present invention further restricts the pure rules from prompting user 4 to publish any private information item. The present invention also enumerates two set of information items as outbound information items by default. The first set includes ad ID and advertiser ID. In another embodiment, the first set further includes the ad body. In another embodiment, the first set further includes the number of supporting fact records as delivered by personal ad manager application 10 to ad insertion script 11 (step 187). The second set includes furnisher ID, current usage, current responses and current recognition, as delivered by the personal ad manager application 10 to global accounts 16 (step 211).

Inbound public information items contain information about user 4 as provided by third parties (personalization). Since user 4 is never prompted to authorize the publication of an information item, including the private copy made from inbound information items, the software programmer skilled in the art will notice that no information item from user profile 5 can be published (confidentiality).

Third party-provided information items cannot match the same level of confidentiality as user-provided information items since the entity responsible for content page 2 already knows the information provided through fact furnishing script 13, even without user authorization. When the advertising system is provided information items by a plurality of suppliers, the confidentiality level reached by the present invention allows advertisers to benefit from the physical aggregation of information items collectively known about user 4 and gathered inside user profile 5 without turning advertising systems manager 7, nor any one else, into a data aggregator. The present invention further allows suppliers to benefit from their collective knowledge about user 4 without anyone of them giving access to one's particular knowledge to any other entity other than user 4. This is in contrast with the disclaimer inserted in traditional corporate privacy policies which states, “confidential user data known to the company is communicated to no one . . . except to partners with which the company has a marketing agreement”.

By restricting ad selector applications 8, the personal ad manager application 10, and the profile feeder application 14 to operate using pure rules, an embodiment of the present invention minimizes user involvement in the operation of the advertising system. User 4 voluntarily enters into an interaction with the supplier responsible for content store 6 for the benefit of receiving copy 3 of content page 2. This interaction allows the supplier to become a supplier of user profile information items and provide the profile feeder application 14 with information items the supplier holds about user 4.

The same interaction also offers the content provider the opportunity to prompt user 4 to reveal new information beyond the original scope of the interaction. This interaction is outside the protection offered by the confidential environment 18. Such user-provided information items held by content user copy 3 can therefore be reported back to the supplier responsible for content store 6. The supplier may abstain from getting a copy of the new information item and instruct content user copy 3 to provide the new information item to fact furnishing script 13 and hence to user profile 5.

If the reputation of the supplier is good, in particular if this supplier subjects itself to regular audits from third parties such as Better Business Bureaus, the user 4 may be willing to provide an answer in the belief that this answer will not become known to anyone else as if it had been revealed within the environment 18. When the user has actually been convinced by a supplier to indirectly participate in the operation of the advertising system for the benefit of all parties: advertisers get more precise targeting; users get more relevant ads without having to publish additional personal information; and fact furnishers get recognized by advertisers for the extra information without having to collect, manage, and sell it. For instance, an online service that sells automotive accessories may prompt its users about car purchase intentions although the service has decided against collecting such user data internally. In another example, an online service that sells books relative to foreign lands may decide to ask customers whether they intend to travel there for business or pleasure while keeping at arms length from the travel and tourism industries. In both cases the online service will still benefit as a supplier of user profile information items.

Since the user profile 5 receives inbound public information items from the fact furnishing script 13 from outside the confidential environment 18, care must be taken to protect inbound information items from observation by third parties during the communication. In one embodiment, both the Discovery and Exploitation Engine (DEP), which runs the profile feeder application 14, and the External Processes (EPR), which runs the fact furnishing script 13, are implemented as trusted Java applets. Because such Java applets are typically embedded in browser pages which do not share the same origin, current browsers will prevent direct communication between the two but will allow them to write and read buffers inside computing environment 17. In one embodiment, the DEP and the EPR use strong cryptographic methods known to the software programmer skilled in the art, such as public key ciphers, to guarantee the confidentiality of the information exchange against third party spying. Although outbound information items do not carry the same insights relative to said user 4, one embodiment of the present invention uses the same technique to protect information exchange between the DEP, which is also responsible for running the personal ad manager application 10, and the EPR which runs ad insertion script 11.

The second step towards ensuring a high level of privacy for user 4 is to limit communications of ad insertion script 11 to the personal ad manager application 10 and to the media store 12. The software engineer skilled in the art will recognize that the communication between ad insertion script 11 and media store 12 provides advertising system manager 7 with a link between the IP address from which ad billing reports and, in one embodiment, advertisement body requests, originate with some formal description of the corresponding advertisement. A typical occurrence for example is Internet connections provided by cable companies, in which the advertising system manager 7 is able to reconstruct a user profile from the subset of advertisements, among those put in the personalized ad store 9 by the ad selector application 8, on the basis of user profile 5, which the personal ad manager application 10 has presented to user 4. The more targeted the advertisements in ad store 9, the more accurate the reconstruction of user profile 5.

Coupled with the ability to link an IP address to a geographic location, the privacy of user 4 can be compromised by the advertising system manager. An embodiment of the present invention prevents these associations by mediating between ad insertion script 11 and media store 12 through anonymizing proxy server 19, which hides the real IP address of user 4 from advertising system manager 7. The software engineer skilled in the art will understand that, while the entity controlling anonymizing proxy server 19 remains able to link the real IP address to a set of advertising reports, this entity is unable to interpret such requests efficiently. Indeed such entity has no access to any formal description of the corresponding advertisements and would only be able to apply pattern recognition techniques to the images and videos typically delivered as advertising bodies by media store 12, a notoriously difficult task. In certain embodiments, media store 12 and ad insertion script 11 use strong cryptographic methods to communicate the advertisement bodies, therefore blinding proxy server 19 to the content of the advertisements.

The software engineer skilled in the art will understand that the two remaining channels recited by the present invention to exist between the external world and confidential environment 18 cannot be used to gain insights into user profile 5. First, the advertisement stream is independent from user profile 5 and can be delivered as a broadcast to ad selector applications 8 run by the advertising system. Second, the reporting stream that the personal ad manager application 10 sends back to global accounts 16 describes how suppliers are recognized by advertisers, independently of both the values of the information items the supplier has provided and the advertisements these values have helped to select. Despite these considerations, one embodiment of the present invention may require these two remaining channels be strongly encrypted to enhance security.

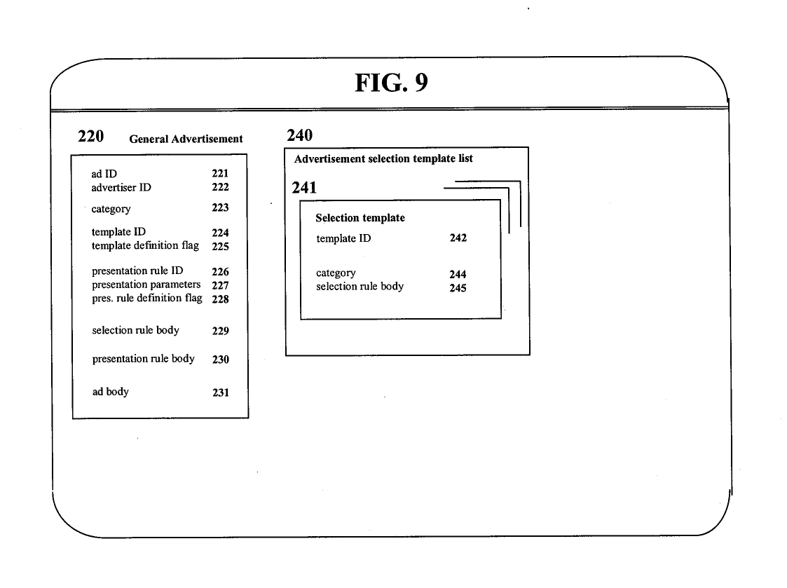

Referring now to FIG. 9, shown is an embodiment in which the advertising system can achieve greater levels of productivity, increasing system efficiency for advertisers' benefit in the process. Advertisements in ad store 1 take on the form of general advertisement 220. Among other data, there is recorded information to be copied upon selection by the ad selector application 8 into the corresponding entry 91 inside personalized ad store 9, i.e. ad ID (221 into 92), advertiser ID (222 into 93), category (223 into 94), presentation rule ID (226 into 95), presentation parameters (227 into 96) and, in certain embodiments, ad body (231 into 108).

In one embodiment, presentation rules in list 110 are predetermined by the advertising system manager and are customized by advertisers using presentation parameters 227, which are advertisement dependent. In another embodiment, individual advertisers are allowed to define their own presentation rules using definition flag 228 and presentation rule body 230. Whenever definition flag 228 is set, the ad selector application 8 first checks whether there exists a record 111 in presentation rule list 110 that has rule ID 112 equal to rule ID 226 and creates a new record if necessary. Into this record, the ad selector application 8 then copies presentation rule body 230 as rule body 113. Whenever definition flag 228 is not set, the ad selector application 8 takes presentation rule ID 226 as a reference to an existing rule inside list 110 and discards general advertisement 220 if no such rule is found. The software programmer skilled in the art will know how to manage the sharing of presentation rule list 110 among all advertisers.

For example one of skill in the art can limit advertisers to reference either their own creation or common system rules by enforcing that presentation rule ID 226 requested by an advertisement be prefixed by the advertiser ID 222 of the advertiser while giving a special prefix to the advertising system manager. List 110 allows advertisements 91 and general advertisements 220 to share presentation rules and thereby to save both storage space and transmission bandwidth. In particular, presentation rule body 230 can be null whenever presentation rule list 110 can resolve the reference to presentation rule ID 226.

The same approach can be applied to the selection rules which are used by advertisers to inform the ad selector application 8 how to verify whether user profile 5 is appropriate. General advertisement 220 contains template ID 224, template definition flag 225 and selection rule body 229. The computing environment includes advertisement selection template list 240 to hold selection templates 241, each such template record made of template ID 242, category 244 and selection rule body 245.

Whenever definition flag 225 is set, the ad selector application 8 first checks whether there exists a record 241 in template list 240 with a template ID 242 that is equal to template ID 224, and creates a new record if necessary. Into this record, the ad selector application 8 then copies selection rule body 229 as rule body 245. In another embodiment, the ad selector application 8 will accept general advertisement 220 with a null ad ID 221 as a way to provision template list 240, and proceed no further. Whenever definition flag 225 is not set, the ad selector application 8 takes template ID 224 as a reference to an existing rule inside list 240 and discards general advertisement 220 if no such rule is found. The software programmer skilled in the art will know how to manage the sharing of template list 240 among advertisers. For example one of skill in the art can limit advertisers to reference either their own creation or common system rules by enforcing that template ID 224 requested by an advertisement be prefixed by the advertiser ID 222 of the advertiser while giving a special prefix to the advertising system manager.

Sharing selection and presentation rules promotes physical resource efficiency, and encourages advertisers to develop complex selection templates and presentation rules because the rules can be so easily stored and reused. For example, multiple messages can be addressed to the same target by crafting general advertisements 220 with a null selection rule body 229 and the same template ID 224 that references a common template downloaded ahead of time. Multiple general advertisements 220 can also be used to build different selection/presentation tactics, for example, linking profile information quality (consistency, likehood and recency) as required by a certain selection rule of template ID 224, with an acceptable offered price as declared in presentation rule parameters 227 for a certain presentation rule of ID 226.

In another embodiment the advertising system manager can also use selection templates 241 to build statistics over the plurality of users 4 present on the system. In this embodiment, the advertising system manager deploys a version of ad insertion script 11 that is modified so the script does not expect an advertisement body from either the personal ad manager application 10 or media store 12. Such a modified script 11 conveys to the personal ad manager application 10 as part of the context (step 180) a request for a special category 94 of advertisements that have a null body 231 and refer to a presentation rule limiting user 4 to one presentation for the duration of the statistic taking.

While user 4 sees no message as a result of this event, ad insertion script 11 will still “bill” a presentation to media store 12 for a special advertiser ID identifying the advertising system manager, and an ad ID that determines the template ID under investigation. The software programmer skilled in the art will appreciate that this allows the advertising system manager to use the billing function of the advertising system as a way to measure how many users 4 in the system satisfy the template, i.e. to compute a statistics for the target described by the template. For instance, using a broad selection criteria, the advertising system manager can count how many active users it can reach over a week who are known to be between 18 and 25 years old. Alternatively, using a narrower criteria, the advertising system manager can count how many active users it can reach over a week who are to be married, living in Boston, and with a disposable annual income above $100,000.

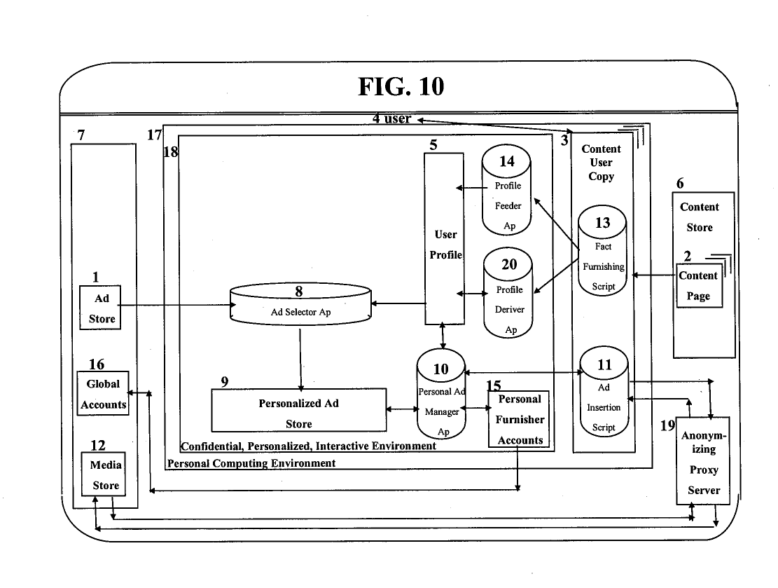

Referring now to FIG. 10, shown is an embodiment in which the advertising system can muster greater participation from suppliers of user profile information to form a user profile 5 having greater depth.

Personalized advertising is based on the ability to characterize a certain desirable target from the values of certain relevant profile information items and encapsulate the link into one selection rule body 229 or one selection template body 245 shared by advertising messages designed with this target in mind. For example, a target such as “likely to be interested in leisure travel to Pacific islands” can be derived from more elementary information items such as “age”, “income”, “time available for vacation”, “purchase of books about Hawaii”, “purchase of videos about Tahiti”. From the advertiser's perspective, asking the user profile 5 to be “inside a target” is akin to verifying the value of a profile information item. In this embodiment, the present invention makes no difference between derived user profile information items, e.g. “likely to be interested in leisure travel to Pacific islands”, and elementary information items, e.g. “age is 35”, and the system allows suppliers to provide both. The more derived information items suppliers provide, the simpler advertisers' selection rules become, down to checking whether “being inside target”, for some certain target, is true or not.

In one embodiment, the system allows external sources to act as indirect suppliers of user profile information items by providing derivation rules rather than information items. Provided with the relevant information items from within the user profile, a derivation rule delivers a new information item, i.e., a derived information item. An additional application, the profile deriver, receives the derivation rules from the suppliers, stores them within the storage device and applies them to the user profile. Whenever the profile deriver generates a new information item from information items within the user profile, the profile deriver application stores the new information item in the storage device together with the information that is necessary to trace the new information item back to the supplier who provided the derivation rule and also to all the information items that supported the derivation and the suppliers who provided them.

Information item derivation rules can use known derived information items as inputs. To trace an advertisement selected for display back to the contributing suppliers, a tracking algorithm used by the personal ad manager is made recursive. When a confidential environment is used to protect the user's privacy, the system makes the derived information item contained in the user profile available for ad targeting without any entity, advertising system manager included, gaining access to these values.

The influence of a derived information item on a particular advertisement presentation and potential user click-through gives rise to the same incremental recognition for the account of the indirect supplier who contributed the derivation rule as for the account of each of the supporting direct suppliers, i.e. those who contributed the information items used in the derivation. In another embodiment, the incremental contribution of the indirect supplier is equal to the sum of the incremental contributions of the supporting direct suppliers.

Some entities, e.g. marketing consultants, can formulate fact derivation rules but do not have access to the elementary data they require. The present invention allows such entities to behave as a suppliers of user profile information, i.e., fact furnisher, by declaring these rules through an appropriate fact furnishing script 13 to profile deriver application 20, operating in the same way as profile feeder application 14 inside the computing environment 17. In these embodiments, the derivation rule supplier is recognized for the derived information item generated from the application of the derivation rule once the supporting user profile information items are present within user profile 5. In certain embodiments, profile deriver application 20 resides on the server computing device configured to interact through the communications system with the client computing devices. In other embodiments, profile deriver application 20 and user profile 5 reside on the client computing device within confidential environment 18.

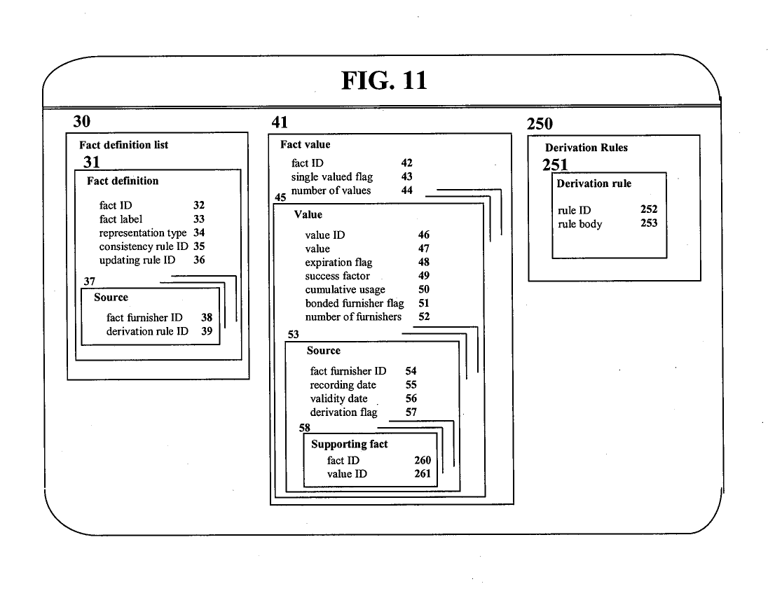

Referring now to FIG. 11, shown are further details on how to implement profile deriver application 20. Profile deriver application 20 functions in a manner similar to the profile feeder application 14. List 250 is set up to store the derivation rules, each formatted as record 251, holding rule ID 252, and rule body 253. In fact definition list 30, fact definition 31 is extended to include a list of derivation sources, each represented by record 37 holding fact furnisher ID 38 and derivation rule ID 39. Referring back to FIG. 6, steps 130 and 132 are extended accordingly to convey both derivation rule ID and rule body between fact furnishing script 13 and profile deriver application 20, responsible for creating corresponding source record 37 and derivation rule record 251.

Because a derivation rule is applicable to users 4 active in the computing environment 17, profile deriver application 20 may perform steps 133-151 as a separate fact recording loop for users 4, not just the one in which interactions have triggered the fact gathering loop, now reduced to steps 130-132. In this particular embodiment, profile deriver application 20 sweeps fact definition list 31 for each user 4 at repeated intervals. For each source record 37, profile deriver application 20 performs steps 133-151. Steps 135 and 141, which deal with the value of the information item at hand, are prefixed with the processing of derivation rule body 253, of which associated rule ID 252 is equal to rule ID 39.

Whenever user profile 5 does not hold an information item referenced by the current derivation rule, the fact recording loop continues and processes the next record 37, i.e. the next derivation rule. Step 138, which deals with the source of the information item concerned, is augmented by flagging the source as a derived supplier, setting derivation flag 57 and creating record 58 for each supporting information item, to hold fact ID 260 and value ID 261. This parallels how the ad selector application 8 fills records 105 for facts supporting an advertisement, emphasizing the equivalence between fact derivation and ad selection. As with selection rules, the advertising system manager may limit the number of supporting information items used by derivation rules. The software engineer skilled in the art will appreciate that derivation rules can use other derived information items as input in a recursive manner, although the advertising system designer may enforce some maximum nesting level for the sake of efficiency.

Whenever the profile deriver application 20 applies a derivation rule, i.e. in the extended steps 135 and 141, the application needs to retrieve record 41 for each supporting information item the rule references. When such an information item has received multiple inconsistent values, i.e. when the corresponding single valued flag 43 is reset, there arises an ambiguity as to which value to use. In one embodiment of the present invention, information items with inconsistent values are simply ignored and the profile deriver application 20 continues and looks for the next rule. In another embodiment, the profile deriver application 20 uses the most likely value, i.e. value 47 for value record 45 with the highest success factor 49. Other embodiments can be readily designed by the software engineer skilled in the art.

When the personal ad manager application 10 performs its accounting loop, the application takes step 191 over each supporting fact. While originally these facts are the ones directly supporting an advertisement per record 105, step 191 can also be called recursively. When a supplier contributes to a single elementary information item, i.e., a direct user profile information item, step 194 processes the corresponding supplier identified by furnisher ID 54 as described above. When a supplier contributes to a derived information item, step 194 processes the supplier responsible for the rule and identified by furnisher ID 54, and further takes each of its own supporting facts into account by executing step 191 on record 58.

Accounting for usage by the personal ad manager application 10 is computed as before by incrementing usage counters 50, 98, 103 and 124 for information items or suppliers directly or indirectly involved in the presentation of an advertisement to user 4. The same applies when user 4 clicks on the advertisement as recorded by incrementing response counters 99, 104 and 125. The software engineer skilled in the art will recognize that success factor 49 is similar since this merely expresses the percentage of what would be a response counter for the corresponding fact value 45 against the usage counter 50.

In certain embodiments, current recognition 126 is different as this counter is meant to record how to split the recognition stemming from a user clicking on advertisement 91 among all involved suppliers. Starting with a recognition value equal to the total recognition computed as before as:

(usage recognition 100*current usage 103+response recognition 101*current responses 104);

personal ad manager application 10 splits this recognition value recursively, as explained below.

Before calling step 191 for the first time, personal ad manager application 10 divides the recognition value by “number of supporting facts” computed as the number of records 105 for advertisement 91. Before calling step 194, personal ad manager application 10 divides the recognition value by “number of contributing sources”, i.e number of furnishers 52 for value 45. Before calling step 191 recursively from within step 194, personal ad manager application 10 divides the recognition value by “number of supporting facts” computed as the number of records 58 for contributing source 53 plus one, and sets aside one such fraction to update the account of fact furnisher 54 for contributing source 53 per step 196.

The software engineer skilled in the art will understand that this algorithm gives the same result as before when no derived information items are involved. He or she will further appreciate that this algorithm gives the same recognition value to the supplier responsible for a derivation rule as to each of the suppliers responsible for the information items referenced by this derivation.

In another embodiment, personal ad manager application 10 splits the recognition value coming to an indirect supplier and the supports in two equal parts, i.e., one half for the indirect supplier, one half to be equally divided among the supports. Other embodiments can be readily designed by the software engineer skilled in the art. In yet another embodiment personal ad manager application 10 assigns no recognition to the indirect supplier and split the recognition coming to the derived information item equally among the supports. For example, when derivation rules are provided directly to the profile deriver application 14 by the advertising system manager, using a pseudo fact furnisher account with a special fact furnisher ID.

The software programmer skilled in the art will understand that, whenever derived information items are used, the advertising manager may wish to vary pricing based on advertisement selection complexity (expressed as number of supporting fact records 105) or derivation complexity. In one embodiment, the ad selector application 8 computes an additional entry, the total number of supporting information items, direct and indirect, held in advertisement record 91 for the personal ad manager application 10 to pass on to said ad insertion script 11 in step 187, instead of number of supporting fact records 105. The total number of supporting information items is computed by ad selector application 8 at the time of selection by using the same recursive traversal of fact value list 40, starting from supporting fact records 105, as used by the modified accounting loop 191 described above.

In another embodiment, advertisers themselves act as suppliers. For example, whenever step 182 reports user 4 has clicked on advertisement 91, the interest in the topic covered by this advertisement can be declared as an information item by the advertiser identified by advertiser ID 93. In another example, an advertiser may request that a selection rule body 229 be stored as a selection template 241 and taken as a derivation rule 251 for some appropriate fact definition 31.

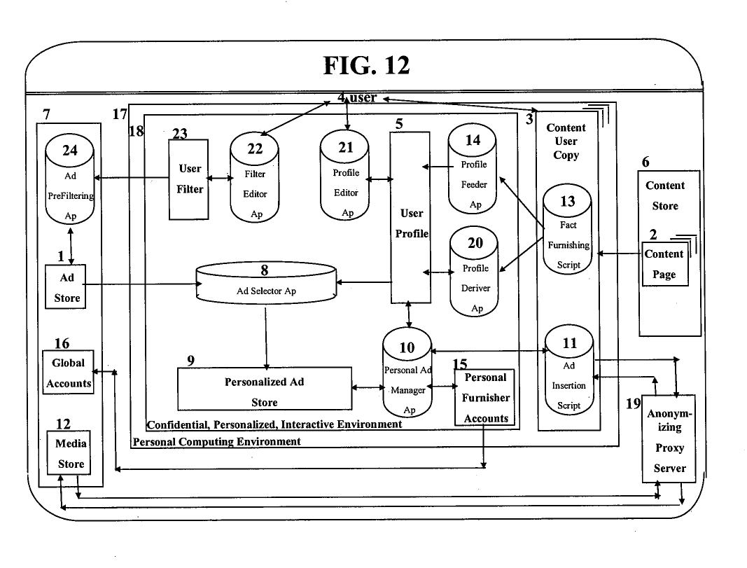

Referring now to FIG. 12, shown is an embodiment in which the advertising system can service active users. One embodiment uses confidential environment 18 within computing environment 17 as active users are most likely to be concerned with privacy risks. Without user involvement, confidential environment 18 maintains a user account for each user 4, for example for each login account on a personal computer. When a real person wants to become involved, this person connects to the appropriate user account within confidential environment 18. The person replaces a computer generated password with a personal password, and the user profile 5 becomes increasingly reliable. Further, the personal password provides that privacy is protected from action by other real users that computing environment 17 would otherwise recognize as the same user 4. In one embodiment, the active user is allowed to prevent suppliers from supplying user profile information items altogether, thereby leaving the advertising system with only passive users or active users who are favorable to such a system. In another embodiment, the system may require users to become active at least to the extent of declaring approval. In general, greater participation by the user yields increased user control and higher targeting quality.

Active users may gain access to their profile through the profile editor application 21. In one embodiment, the profile editor application 21 provides user 4 with read-only access to data recorded in profile 5. This is enough for the user to spot erroneous entries and trace them back using source entries 53 and fact furnisher list 60 to the suppliers responsible for the errors. Suppliers that provide information items directly may further provide a redress process through which user 4 may ask for an appropriate content page 2 and interact with page 2 to effect the desired correction within user profile 5. When derivation flag 57 signals an indirect value, the user can trace it back recursively to its supporting direct sources through records 58.

Suppliers that provide derivation rules may also provide the user with an explanation process to further understand the logic behind each derivation. Users can also avail themselves of other forms of redress through the advertising system manager. For example, a user may report suppliers that do not provide a satisfactory redress process. Such suppliers may become expelled from the advertising system as unreliable partners. Additionally, the user may ask for arbitration of a dispute over a value 47 if bonded status 64 of value 47 is set. In this embodiment, the bonded supplier may be legitimately unwilling to let the user correct the entry as such entries are likely to be more meaningful, for instance when entries reflect the credit of some user 4.

The advertising system manager is responsible to administer such an arbitration process. The system manager may further penalize bonded suppliers for any correction that is found to be justified and use the penalties to compensate advertisers whose selection rules rely on the disputed information item. In another embodiment, profile editor application 21 provides user 4 with read-write access to profile data, with the exception of bonded entries. To maintain the integrity of supplier user profile information items, write authorization is limited to deleting a value record 45 or to adding a value record 45 using a generic fact furnisher ID code which stands for “user-provided”. In another embodiment, the advertising system manager may choose to let users provide specific fact furnisher ID's and recognize such users as it would any other supplier.

Active users may also impose some pre-filtering on the stream of advertisements issuing from ad store 1. In certain embodiments, pre-filtering cuts down on the resources consumed by the transmission of the stream to the ad selector application 8 and by the operation of application 8. In other embodiments, pre-filtering turn the advertising system into a source of appropriate information when user 4 has a specific need in mind. In this embodiment, the filter editor application 22, allows user 4 to declare a user filter 23 which can be downloaded by the ad pre-filtering application 24 to limit the output of ad store 1 to the subset of advertisements that satisfy the criteria of user filter 23.

For an example of implementation the software engineer skilled in the art is referred to U.S. Pat. Application No. 2006/0053279. U.S. Pat. Application No. 2006/0053279 further describes how the advertising system manager, acting as a system operator, can provide templates from which users can prepare their filters. In one embodiment the advertising system manager can constrain user 4 to derive user filter 23 from such templates and design such templates so as to limit user capacity to influence the advertisement stream received by the ad selector application 8. This allows the advertising system manager to balance the interests of users, advertisers, and space sellers. For instance, the advertising system manager can let users pre-select advertisements subject to some threshold in volume over a given period. The system can further tie the threshold to a subscription fee paid by the user who desires to receive less advertising.

While certain embodiments according to the present invention have been shown and/or described, it should be understood that the invention is not limited to just those embodiments. Various changes, additions and/or deletions are possible without departing from the spirit and scope of the invention. Also, various combinations of disclosed elements, features, etc. are possible and within the scope of the disclosure even if specific combinations are not expressly described therein. All references, including issued patents and published patent applications, are incorporated herein in their entireties.

What is claimed is:

1. Apparatus for providing compensation to suppliers of information, the apparatus comprising:
a storage device; and
a server computing device in communication with the storage device and configured to interact over a communications system with one or more client computing devices, each of the client computing devices having associated therewith one or more user profiles, each of the user profiles including one or more user profile information items, each of the user profile information items from one of one or more suppliers, the server computing device also configured to execute one or more computer programs that, for each of the user profiles:
collect the user profile information items based on a user employing one of the client computing devices to access over the communications system web pages of one or more of the suppliers;
determine the identity of each of the suppliers associated with each of the collected user profile information items, and store in the storage device information about those identities and associations;
select, based on the user profile, one or more advertisements from a plurality of possible advertisements, and store in the storage device the selected advertisements and information about the user profile upon which the selection was based;
present one or more of the selected advertisements as a user employs one of the client computing devices to access over the communications system web pages that include one or more advertisement spaces;
access at least some of the information stored in the storage device to determine the identity of at least one of the suppliers associated with at least one of the user profile items used in the selection of at least one of the presented advertisements; and
provide compensation to at least the at least one supplier whose identity was determined.

2. The apparatus of claim 1, wherein the storage device comprises computer storage in one or more of: the server computing device, one or more external storage units local to the server computing device, and one or more external storage units remote from the server computing device.

3. The apparatus of claim 1, wherein the server computing device comprises a single general purpose computer or multiple general purpose computers.

4. The apparatus of claim 1, wherein the suppliers comprise business entities.

5. The apparatus of claim 4, wherein business entities have web pages that contain content and a dynamic executable module.

6. The apparatus of claim 1, wherein the server computing device presents one or more of the selected advertisements upon a request from the web pages that include the advertisement spaces through a dynamic executable module.

7. The apparatus of claim 1, wherein the server computing device provides compensation to each of the suppliers associated with each of the user profile items used in the selection of at least one of the presented advertisements.

8. The apparatus of claim 1, wherein the compensation is one or more of: points, money, and credits.

9. The apparatus of claim 1, wherein the plurality of possible advertisements is received from advertisers that elect to interact through the communications system with the apparatus.

10. The apparatus of claim 1, wherein the server computing device also charges an advertiser associated with the presented advertisement.

11. The apparatus of claim 1, wherein the server computing device collects the user profile information items by at least one rule.

12. The apparatus of claim 1, wherein the server computing device also determines whether an identical user profile information item is provided by more than one supplier.

13. The apparatus of claim 1, wherein the server computing device also determines whether a newly collected user profile information item is consistent with the user profile by referring to a list of consistency rules.

14. The apparatus of claim 1, wherein the server computing device also keeps the user profile current by referring to a list of updating rules.

15. The apparatus of claim 1, wherein a supplier can obtain exclusivity over the sourcing of a user profile information item.

16. The apparatus of claim 1, wherein the server computing device also derives at least one additional user profile information item based on an existing user profile.

17. The apparatus of claim 16, wherein the server computing device also provides compensation to at least the at least one supplier of the user profile information item in the user profile that contributed to a derived user profile information item.

18. The apparatus of claim 16, wherein the server computing device executes at least one derivation according to a derivation rule, supplied by a rule supplier, and provides compensation to the rule supplier of the at least one derivation rule used to derive a user profile information item.

19. The apparatus of claim 1, wherein the server computing device selects by comparing one or more selection criteria embedded in the one or more advertisements against the information items in the user profile.

20. Apparatus for providing compensation to suppliers of information, the apparatus comprising:
a storage device and;
a client computing device configured to interact over a communications system with one or more server computing devices, the client computing device in communication with the storage device that is maintained inside a security wall on the client computing device, the storage device holding one or more user profiles, each of the user profiles including one or more user profile information items, each of the user profile information items from one of one or more suppliers, the client computing device also configured to execute one or more computer programs that are maintained inside the security wall that, for each of the user profiles:
collect the user profile information items based on a user employing one of the client computing devices to access over the communications system web pages of one or more of the suppliers;
determine the identity of each of the suppliers associated with each of the collected user profile information items, and store in the storage device information about those identities and associations;
select, based on the user profile, one or more advertisements from a plurality of possible advertisements, and store in the storage device the selected advertisements and information about the user profile upon which the selection was based;
present one or more of the selected advertisements as a user employs the client computing device to access over the communications system web pages that include one or more advertisement spaces;
access at least some of the information stored in the storage device to determine the identity of at least one of the suppliers associated with at least one of the user profile items used in the selection of at least one of the presented advertisements; and
provide compensation to at least the at least one supplier whose identity was determined.

21. The apparatus of claim 20, wherein the client computing device allows a user to secure their corresponding user profile.

22. The apparatus of claim 20, wherein the client computing device allows the user to prevent a specific supplier of user profile information from contributing a user profile information item.

23. The apparatus of claim 20, wherein the client computing device allows the user to edit their corresponding user profile.

24. The apparatus of claim 20, further including an anonymizing proxy server used by the client computing device to communicate with the one or more server computing devices.

25. Method for providing compensation to suppliers of information, the method comprising:
providing one or more client computing devices to access one or more server computing devices in communication with one or more storage devices, each of the server computing devices configured to interact over a communications system with each of the client computing devices, each of the client computing devices having associated therewith one or more user profiles, each of the user profiles including one or more user profile information items, each of the user profile information items from one of one or more suppliers, the method further comprising, for each user profile:
collecting the user profile information items based on a user employing one of the computing devices to access over a communications system web pages of one or more of suppliers;
determining the identity of each of the suppliers associated with each of the collected user profile information items, and storing in the storage device information about those identities and associations;
selecting, based on the user profile, one or more advertisements from a plurality of possible advertisements, and storing in the storage device the selected advertisements and information about the user profile upon which the selection was based;
presenting one or more of the selected advertisements as the user employs one of the client computing devices to access over the communications system web pages that include one or more advertisement spaces;
accessing at least some of the information stored in the storage device to determine the identity of at least one of the suppliers associated with at least one of the user profile items used in the selection of at least one of the presented advertisements; and
providing compensation to at least the at least one supplier whose identity was determined.

26. The method of claim 25, wherein the storage device comprises computer storage in one or more of: the server computing device, one or more external storage units local to the server computing device, and one or more external storage units remote from the server computing device.

27. The method of claim 25, wherein the server computing device comprises a single general purpose computer or multiple general purpose computers.

28. The method of claim 27, wherein the suppliers comprise business entities.

29. The method of claim 28, wherein the business entities have web pages that contain content and a dynamic executable module.

30. The method of claim 25, wherein the server computing device presents one or more of the selected advertisements upon a request from the web pages that include the advertisement spaces through a dynamic executable module.

31. The method of claim 25, further including providing compensation to each of the suppliers associated with each of the user profile items used in the selection of at least one of the presented advertisements.

32. The method of claim 25, wherein the compensation is one or more of: points, money, and credits.

33. The method of claim 25, wherein the plurality of possible advertisements is received from advertisers that elect to interact through the communications system with the apparatus.

34. The method of claim 25, further including charging an advertiser associated with the presented advertisement.

35. The method of claim 25, wherein collecting the user profile information items is by at least one rule.

36. The method of claim 25, further including determining whether an identical user profile information item is provided by more than one supplier.

37. The method of claim 25, further including determining whether a newly collected user profile information item is consistent with the user profile by referring to a list of consistency rules.

38. The method of claim 25, further including keeping the user profile current by referring to a list of updating rules.

39. The method of claim 25, wherein a supplier can obtain exclusivity over the sourcing of a user profile information item.

40. The method of claim 25, further including deriving at least one additional user profile information item based on an existing user profile.

41. The method of claim 40, further including providing compensation to at least the at least one supplier of the user profile information item in the user profile that contributed to a derived user profile information item.

42. The method of claim 40, further including executing at least one derivation according to a derivation rule, supplied by a rule supplier, and providing compensation to the rule supplier of the at least one derivation rule used to derive a user profile information item.

43. The method of claim 25, wherein the step of selecting is by comparing one or more selection criteria embedded in the one or more advertisements against the information items in the user profile.

44. Method for providing compensation to suppliers of information, the method comprising:
providing one or more client computing devices configured to interact over a communications system with one or more server computing devices, each of the client computing devices in communication with a storage device that is maintained inside a security wall on each of the client computing devices, the storage device holding one or more user profiles, each of the user profiles including one or more user profile information items, each of the user profile information items from one of one or more suppliers, the method further comprising, for each user profile:
collecting the user profile information items based on a user employing one of the client computing devices to access over the communications system web pages of one or more of the suppliers;
determining the identity of each of the suppliers associated with each of the collected user profile information items, and storing in the storage device information about those identities and associations;
selecting, based on the user profile, one or more advertisements from a plurality of possible advertisements, and storing in the storage device the selected advertisements and information about the user profile upon which the selection was based;
presenting one or more of the selected advertisements as a user employs the client computing device to access over the communications system web pages that include one or more advertisement spaces;
accessing at least some of the information stored in the storage device to determine the identity of at least one of the suppliers associated with at least one of the user profile items used in the selection of at least one of the presented advertisements; and
providing compensation to at least the at least one supplier whose identity was determined.

45. The method of claim 44, further including securing the user profile.

46. The method of claim 45, further including preventing a specific supplier of user profile information from contributing a user profile information item.

47. The method of claim 44, further including editing the user profile.
